(19) United States
(12) Patent Application Publication
(10) Pub. No.: US 2010/0035596 A1
(43) Pub. Date: Feb. 11, 2010

(54) HANDHELD NAVIGATION UNIT WITH TELEPHONE CALL

(75) Inventors: George L. Nachman, Sunnyvale, CA (US); Sachin S. Kansal, Sunnyvale, CA (US); Robert Y. Haitani, Menlo Park, CA (US); Krzysztof J. Kowalczyk, San Francisco, CA (US); David G. Champlin, San Diego, CA (US)

Correspondence Address: FOLEY & LARDNER LLP, 777 EAST WISCONSIN AVENUE, MILWAUKEE, WI, 53202-5306, US

(73) Assignee: Palm, Inc.

(21) Appl. No.: 12/502,159

(22) Filed: Jul. 13, 2009

Related U.S. Application Data
(62) Division of application No. 11/292,562, filed on Dec. 2, 2005.

(51) Int. Cl. H04M 3/00; G06F 3/048

(52) U.S. Cl. 455/418; 715/810; 715/764; 455/566

(57) ABSTRACT

A system, apparatus, and method for techniques to retrieve and process information from communication networks on a mobile computing device are described. The apparatus may include a first interface module to receive a query and to display results of said query. The results include location information of at least one entity associated with the query. The apparatus may include a second interface module to transfer the query to a data source server, receive the results from the data source server, and transfer the results to said first interface. Other embodiments are described and claimed.

### BACKGROUND

Communication and computing technologies are starting to converge into a single mobile computing device with continuously decreasing form factors. For example, handheld “smart phones” are emerging that combine capabilities such as voice and data communications typically provided by a cellular telephone with application programs typically provided by a computer. Consequently, a mobile user may use a single device to make telephone calls, maintain calendars and contacts, browse the Internet, communicate electronic mail (“email”), and more. The increased levels of functionality, however, may provide an increased level of complexity for a user, thereby potentially limiting the usefulness of some smart phones.

Mobile computing devices such as handheld smart phones enable mobile users to perform multiple functions. For example, handheld smart phones enable mobile users to manage their personal information managers (PIM), make and receive calls, communicate with other users over email, short message service (SMS), instant messaging (IM), browse the Internet (e.g., world wide web or web), and store data, among other functions. With access to the web, a mobile user has access to all the information on the Internet. Given the limited screen size, limited data input methods, and processing power of a handheld smart phone, however, the web experience on a handheld device is not as compelling as a desktop computer.

Mobile users generally have their mobile computing device wherever they go most times of the day. This makes the mobile computing device a useful medium for the mobile user to retrieve time and location dependent information and act on the information. In general, mobile users may want to know their location irrespective of the source of the location information and may want to then take some actions according to that location. Common examples of information that a mobile user may find useful to retrieve using a mobile computing device may include the location of the nearest business establishment and directions on how to get there. This may include the location of the nearest coffee shop, which movie is playing at a nearby cinema hall and whether tickets may be purchased while still in the car, retrieve the phone number of a restaurant and call to make reservations, and determine the traffic conditions on a particular route, among others.

### BRIEF DESCRIPTION OF THE DRAWINGS

FIG. 1 illustrates one embodiment of a system.

FIG. 2 illustrates one embodiment of a node.

FIG. 3 illustrates one embodiment of a radio sub-system.

FIG. 4 illustrates one embodiment of a processing sub-system.

FIG. 5 illustrates one embodiment of a software architecture.

FIG. 6 illustrates one embodiment of a user interface screen.

FIG. 7A illustrates one embodiment of a screen.

FIG. 7B illustrates one embodiment of a screen.

FIG. 7C illustrates one embodiment of a screen.

FIG. 7D illustrates one embodiment of a dialog screen.

FIG. 7E illustrates one embodiment of a dialog screen.

FIG. 8A illustrates a basic search results screen.

FIG. 8B illustrates a search results screen.

FIG. 8C illustrates one embodiment of a map.

FIG. 8D illustrates one embodiment of a map.

FIG. 8E illustrates one embodiment of a directions display screen.

FIG. 8F illustrates one embodiment of a contacts list pop-up screen.

FIG. 8G illustrates one embodiment of an address lookup screen.

FIG. 8H illustrates one embodiment of a dial screen.

FIG. 8I illustrates one embodiment of a basic search results screen.

FIG. 9A illustrates one embodiment of a driving directions interface screen.

FIG. 9B illustrates one embodiment of a driving directions interface screen.

FIG. 10A illustrates one embodiment of a map interface screen.

FIG. 10B illustrates one embodiment of a map interface screen.

FIG. 11 illustrates one embodiment of a logic flow diagram.

FIG. 12 illustrates one embodiment of a map pin.

FIG. 13A illustrates one embodiment of multiple map pins overlaid on a bitmap map to mark the location of various points of interest on the bitmap map.

FIG. 13B illustrates one embodiment of multiple spread-out map pins overlaid on a bitmap map to mark the location of various points of interest on the bitmap map.

FIG. 14 illustrates one embodiment of a logic flow diagram to implement a map pin spread module.

### DETAILED DESCRIPTION

Various embodiments of a mobile computing device platform including one or more application clients are described herein. The mobile computing device platform enables application clients to provide mobile users with access to information available on worldwide communications networks. The application clients process the retrieved information and render it in a format that is compatible with a mobile computing device display. The types of information that are accessible to a mobile user is widely varied and may include, for example, location information, map information, and/or enhanced content such as traffic information, points of interest information, and the like. The mobile computing device platform described herein may be implemented as an open platform and may be adaptable to execute one or more application clients. The application clients may provide the necessary interface to existing web related and wireless services, support global positioning satellite (GPS) navigation modules, process browser based content, and operate with one or more wireless mobile computing devices and web applications, for example.

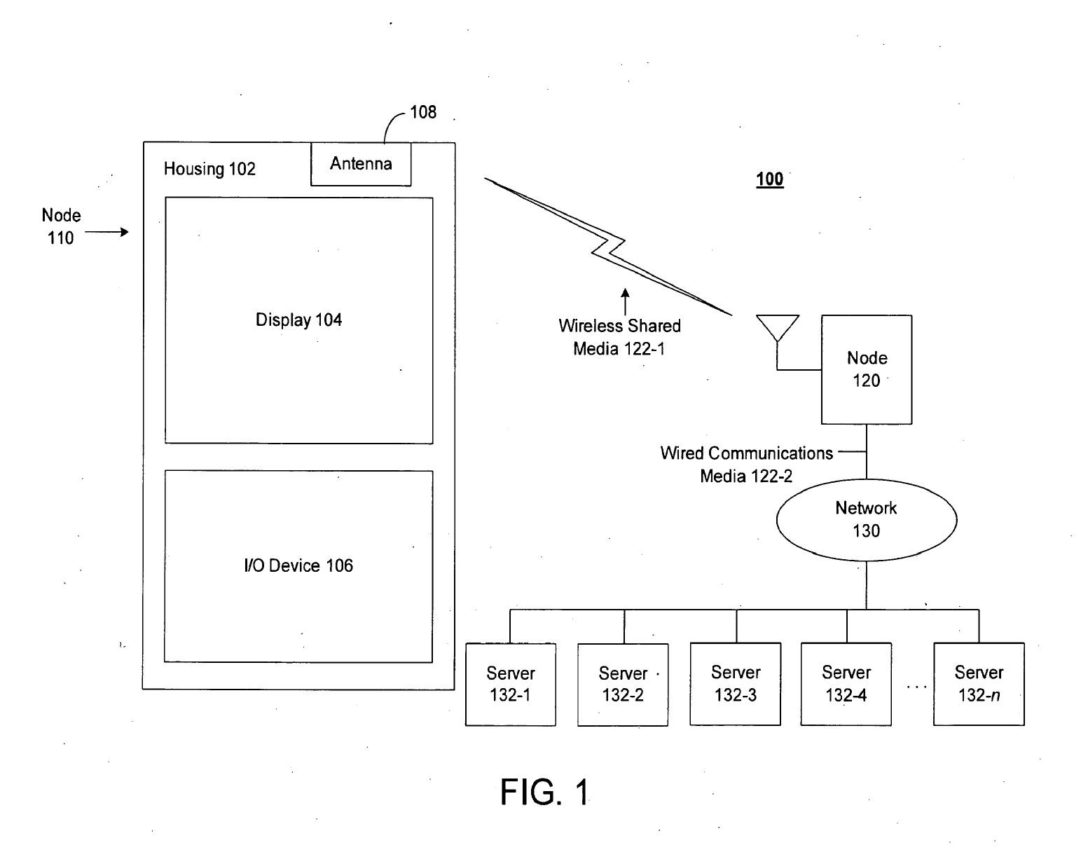

FIG. 1 illustrates one embodiment of a system. FIG. 1 illustrates a block diagram of a system 100. In one embodiment, for example, system 100 may comprise a communication system having multiple nodes. A node may comprise any physical or logical entity for communicating information in system 100 and may be implemented as hardware, software, or any combination thereof, as desired for a given set of design parameters or performance constraints. Although FIG. 1 is shown with a limited number of nodes in a certain topology, it may be appreciated that system 100 may include more or less nodes in any type of topology as desired for a given implementation. The embodiments are not limited in this context.

In various embodiments, a node may comprise a device, such as a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In various embodiments, a node or a portion of a node may be implemented using hardware, software, or a combination of both. For example, the hardware may include electronic elements fabricated on a substrate. In various implementations, the electronic elements may be fabricated using silicon-based integrated circuit (IC) processes such as complementary metal oxide semiconductor (CMOS), bipolar, and bipolar CMOS (BiCMOS) processes, for example. Examples of hardware may include electrical or electronic elements, such as a microprocessor, an integrated circuit, a programmable logic device (PLD), a digital signal processor (DSP), a processor, a circuit, a logic gate, a register, a microprocessor, an integrated circuit, a semiconductor device, a chip, a transistor, and so forth. The embodiments are not limited in this context.

In various embodiments, a node or portions of a node may be implemented using software. The term “software” may refer to program instructions and/or data adapted for execution by a processor. The term “program instructions” may refer to an organized list of commands comprising words, values or symbols arranged in a predetermined syntax, that when executed, may cause a processor to perform a corresponding set of operations. Examples of a computer language may include C, C++, Java, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software also may be stored on the media as compressed and/or encrypted data. As used herein, the term “software” may generically encompass any type of software, such as programs, applications, computer programs, application programs, system programs, machine programs, operating system software, middleware, firmware, software modules, routines, subroutines, method, procedures, functions, software interfaces, application program interfaces (API), instruction sets, computing code, computer code, code segments, computer code segments, words, values, symbols, or any combination thereof. The embodiments are not limited in this context.

System 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an input/output (I/O) adapter. The I/O adapter may be arranged to operate with any suitable technique for controlling information signals between nodes using a desired set of communications protocols, services or operating procedures. The I/O adapter also may include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 100 may include one or more wireless nodes arranged to communicate information over one or more types of wireless communication media, sometimes referred to herein as wireless shared media. An example of a wireless communication media may include portions of a wireless spectrum, such as one or more frequencies or frequency bands of the radio-frequency (RF) spectrum. The wireless nodes may include components and interfaces suitable for communicating information signals over the designated wireless spectrum, such as one or more antennas, radios, wireless transmitters/receivers (“transceivers”), baseband processors, amplifiers, filters, control logic, and so forth. As used herein, the term “transceiver” may be used in a very general sense to include a transmitter, a receiver, or a combination of both. The embodiments are not limited in this context.

Various embodiments may be directed to techniques to retrieve and process location information from communications networks on a mobile computing device, such as a smart phone. In one embodiment, for example, a mobile computing device may comprise a radio sub-system to provide voice and/or data communications, and a processing sub-system to connect to the radio sub-system. The processing sub-system may have a processor and memory. The memory may store software components for execution by the processor. The software components may include an application client and multiple server access modules, each corresponding to a different type of application server. Each server access module may comprise a data synchronization module to synchronize information between the application client and a corresponding application server, a protocol translation module to communicate information using an application server protocol for the corresponding application server, and a data format converter to convert information between an application client data format for the application client and an application server data format for the corresponding application server. Consequently, various embodiments may potentially improve performance of a mobile computing device. Accordingly, a user may realize enhanced products and services.

In various embodiments, system 100 may include a wireless node 110. Wireless node 110 may comprise any node arranged with wireless capabilities. Examples of wireless node 110 may include any of the examples for a node previously described. The embodiments are not limited in this context.

In one embodiment, for example, wireless node 110 may be implemented as a mobile computing device having wireless capabilities. A mobile computing device 110 may refer to any device having a processing system and a mobile power source or supply, such as one or more batteries, for example. Examples of a mobile computing device 110 may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device 110 also may include computers that are arranged to be worn by a person, such as a wrist computer, finger computer, ring computer, eyeglass computer, belt-clip computer, arm-band computer, shoe computers, clothing computers, and other wearable computers. In one embodiment, for example, mobile computing device 110 may be implemented as a smart phone capable of executing computer applications, as well as voice communications and/or data communications. Although some embodiments may be described with mobile computing device 110 implemented as a smart phone by way of example, it may be appreciated that other embodiments may be implemented using other wireless mobile computing devices as well. The embodiments are not limited in this context.

As shown in FIG. 1, mobile computing device 110 may comprise housing 102, display 104, input/output (I/O) device 106, and antenna 108. I/O device 106 may comprise a microphone and speaker, for example. Display 104 may comprise any suitable display unit for displaying information appropriate for a mobile computing device. I/O device 106 may comprise any suitable I/O device for entering information into a mobile computing device. Examples for I/O device 106 may include an alphanumeric keyboard, a numeric keypad, a touch pad, input keys, buttons, switches, rocker switches, voice recognition device and software, and so forth. Information also may be entered into mobile computing device 110 by way of microphone. Such information may be digitized by a voice recognition device. The embodiments are not limited in this context.

In one embodiment, system 100 may include a wireless node 120. Wireless node 120 may comprise, for example, a mobile station or fixed station having wireless capabilities. Examples for wireless node 120 may include any of the examples given for mobile computing device 110, and further including a wireless access point, base station or node B, base station radio/transceiver, router, switch, hub, gateway, and so forth. In one embodiment, for example, wireless node 120 may comprise a base station for a cellular radiotelephone communications system. Although some embodiments may be described with wireless node 120 implemented as a base station by way of example, it may be appreciated that other embodiments may be implemented using other wireless devices as well. The embodiments are not limited in this context.

In one embodiment, mobile computing device 110 and wireless node 120 may comprise part of a cellular communication system. Examples of cellular communication systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, Narrowband Advanced Mobile Phone Service (NAMPS) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth. The embodiments are not limited in this context.

In addition to voice communication services, mobile computing device 110 and wireless node 120 may be arranged to communicate using a number of different wireless wide area network (WWAN) data communication services. Examples of cellular data communication systems offering WWAN data communication services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, and so forth. The embodiments are not limited in this respect.

In one embodiment, communication system 100 may include network 130 connected to wireless node 120 by wired communications medium 122-2. Network 130 may comprise additional nodes and connections to other networks, including a voice/data network such as the Public Switched Telephone Network (PSTN), a packet network such as the Internet, a local area network (LAN), a metropolitan area network (MAN), a wide area network (WAN), an enterprise network, a private network, and so forth. In one embodiment, for example, network 130 may be arranged to communicate information in accordance with one or more Internet protocols as defined by the Internet Engineering Task Force (IETF), such as the Transmission Control Protocol/Internet Protocol (TCP/IP), for example. Network 130 also may include other cellular radio telephone system infrastructure and equipment, such as base stations, mobile subscriber centers, central offices, and so forth. The embodiments are not limited in this context.

In various embodiments, network 130 may be connected to one or more servers 132-1-n. Servers 132-1-n may comprise any type processing system, such as a computer, server, web server, workstation or other processing device. The processing system may comprise, for example, a processor and memory. In some embodiments, servers 132-1-n may execute one or more application server programs. For example, server 132-1-n may each have the appropriate hardware and software to operate as an application server. Examples of an application server may include a server arranged to execute any type of application server programs, including groupware software or collaborative software (collectively referred to as “groupware”). Groupware may refer to a type of application software that integrates work on a single project by several concurrent users at separated nodes (e.g., workstations). Groupware may be divided into three categories depending on the level of collaboration. A first groupware category may include electronic communication tools, such as email software, faxing software, voice mail software, web publishing software, and so forth. A second groupware category may include conferencing tools, such as data conferencing software, video conferencing software, voice conferencing software, Internet forum software, chat room software, electronic meeting system software, and so forth. A third groupware category may include collaborative management tools, such as electronic calendar software, project management system software, workflow system software, knowledge management system software, social software, and so forth. The embodiments are not limited in this context.

In one embodiment, for example, application servers 132-1-n may be implemented as mail servers capable of storing and communicating messages with an application client present on certain nodes in system 100, such as mobile computing device 110. The messages may be in a text format or a multimedia format. An example of a multimedia format may include a Multipurpose Internet Application Extensions (MIME) format. Communications between servers 132-1-n and mobile computing device 110 may be accomplished via wireless node 120 and network 130, for example. Servers 132-1-n also may be capable of communicating messages to an application client present on other wired and wireless nodes accessible by servers 132-1-n via network 130 or other networks. It may be appreciated that although application servers 132-1-n may be described in the context of mail applications by way of example, it may be appreciated that application servers 132-1-n may use other application software as desired for a given implementation. The embodiments are not limited in this context.

In various embodiments, application servers 132-1-n may be arranged to communicate information in accordance with a number of different application server protocols. In one embodiment, for example, application servers 132-1-n may be implemented as email servers. For example, server 132-1 may comprise a Post Office Protocol (POP) mail application server, such as a POP3 mail server. In another example, server 132-2 may comprise an Internet Message Access Protocol (IMAP) mail application server, such as an IMAP4 mail application server. In yet another example, server 132-3 may comprise a Microsoft Exchange ActiveSync® (EAS) mail application server. In still another example, server 132-4 may comprise a WebDAV mail application server. In addition, one or more servers 132-1-n also may be arranged to send messages over network 130 using one protocol, such as a Simple Application Transfer Protocol (SMTP) or Extended SMTP (ESMTP), and receive messages using another protocol, such as POP3 or IMAP4. The embodiments are not limited in this context.

In one embodiment, for example, application servers 132-1-n may be implemented as data sources or backend services servers. Data sources or backend services include Internet based search engines, map, and location services, among other web services or tools for finding resources on the World Wide Web. Data sources or backend services scan web pages to find instances of keywords entered by a user in a search box. Examples of data sources or backend services include GOOGLE™, YAHOO®, TELCONTAR, MAPQUEST®, ASKJEEVES®, RAND MC NALLY, among others. Map data sources use map creation software to generate maps and directions based on location information provided by a user in a search box. The search box information (e.g., query) may be transmitted from node 110 to any one of servers 132-1-n and map and directions data may be provided by servers 132-1-n via network 130 back to node 110 via wireless node 120, for example. Data source and backend services servers 132-1-n also may include Assisted Global Positioning System (AGPS), a land station that assists Global Positioning System (GPS) devices in acquiring position. It will be appreciated that AGPS may be considered a variant of GPS used in mobile computing devices, such as cell phones, for example. For example, AGPS may use an assistance server 132-1-n to reduce the time needed to find a location. Another example of a data source or backend service includes services that provide DRILL DOWN SERVERS™ (DDS), such as TELCONTAR, for example. It will be appreciated that a DDS is a spatial query server that provides core features required for location-based applications and services, including: routing, mapping, geocoding, and reverse geocoding, for example. It also supports more advanced applications including real-time navigation, guidance, and traffic information, as well as vehicle tracking. Other examples of data sources or backend services include, for example, UNIVERSAL TELEMATICS SERVER™, RICH MAP ENGINE®, and TRAFFIC MANAGER™, also provided by TELCONTAR, to offer end users asset or resource management, MSSC, real-time navigation and traffic information, driving directions, roadside or emergency assistance, and maps. The embodiments are not limited in this context.

In various embodiments, mobile computing device 110 and wireless node 120 also may be capable of voice and/or data communications. Communications between mobile computing device 110 and wireless node 120 may be performed over wireless shared media 122-1 in accordance with a number of wireless protocols. Examples of wireless protocols may include various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may include various WWAN protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may include wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may include near-field communication techniques and protocols, such as electro-magnetic induction (EMI) techniques. An example of EMI techniques may include passive or active radio-frequency identification (RFID) protocols and devices. Other suitable protocols may include Ultra Wide Band (UWB), Digital Office (DO), Digital Home, Trusted Platform Module (TPM), ZigBee, and other protocols. The embodiments are not limited in this context.

In various embodiments, mobile computing device 110 may have one or more application client modules arranged to retrieve and process information from network 130 (e.g., servers 132-1-n) and display the information on display 104 or audibly announce the information by way of speaker. The mobile computing device 110 may be implemented as an open platform adaptable to execute one or more application client programs and integrate with third party software application client programs. The application client modules may provide the necessary interface to existing data sources or backend services, such as web related and wireless services, support GPS navigation modules, process browser based content, and operate with one or more wireless mobile computing devices and web applications, for example. In one embodiment, the application client modules may integrate with third party application client programs via APIs to retrieve location information, such as, for example, geographic coordinates, map interfaces, queries for search engines, interfaces to third party location based services (LBS), and any other services provided via servers 132-1-n, and the like. The application client modules may include a user interface layer to process search queries, search results, display maps (e.g., zoom/pan), provide turn-by-turn directions, provide voice activated turn-by-turn directions, and provide permission based interface for LBS type location information, among others. The application client modules also may include an interface layer to process local information, point of interface (POI) data, and a data abstraction layer to process map data, for example. The application client modules also may process data from various data sources or backend services distributed throughout network 130 (e.g., servers 132-1-n) such as, for example, GPS integrated circuits located either on or off mobile computing device 110, carrier AGPS, various prolific search engines (e.g., GOOGLE™®, YAHOO®, and the like), vector data, tile data, among others, for example. It will be appreciated by those skilled in the art that tile data may be defined as a spatial unit representing a sub-region of an image, usually of rectangular nature, by which geographic data is organized, subdivided, and stored in a map library. The embodiments are not limited in this context.

Various embodiments may address these and other problems. In one embodiment, for example, mobile computing device 110 may employ a software architecture for retrieving and processing information from a communications network. The software architecture may enable mobile computing device 110 to communicate and process information from network 130 and servers 132-1-n, for example. The software architecture includes component implementations and specifies standard programmatic interfaces such as APIs to assist in the common requirements of retrieving information wirelessly between an application client and multiple data source servers. As a result, the software architecture may provide a method to enable application clients to interact with disparate data providers.

In one embodiment, for example, the software architecture may be implemented using object-oriented programming (OOP) techniques. OOP is a computer programming paradigm. OOP assumes that a computer program is composed of a collection of individual units, or objects, as opposed to a traditional assumption that a program is a list of instructions to the computer. Each object is capable of receiving messages, processing data, and sending messages to other objects. Almost any concept may be represented as an object. Examples of an object may include menu objects, image objects, frame objects, title objects, border objects, tab objects, list objects, color blue objects, button objects, scroll bar objects, input field objects, text and image objects, and so forth. Although the software architecture may be described in the context of OOP by way of example, it may be appreciated that other software paradigms may be used as desired for a given implementation. For example, the software architecture may be implemented using a model-view-controller (MVC) architecture as well. The embodiments are not limited in this context.

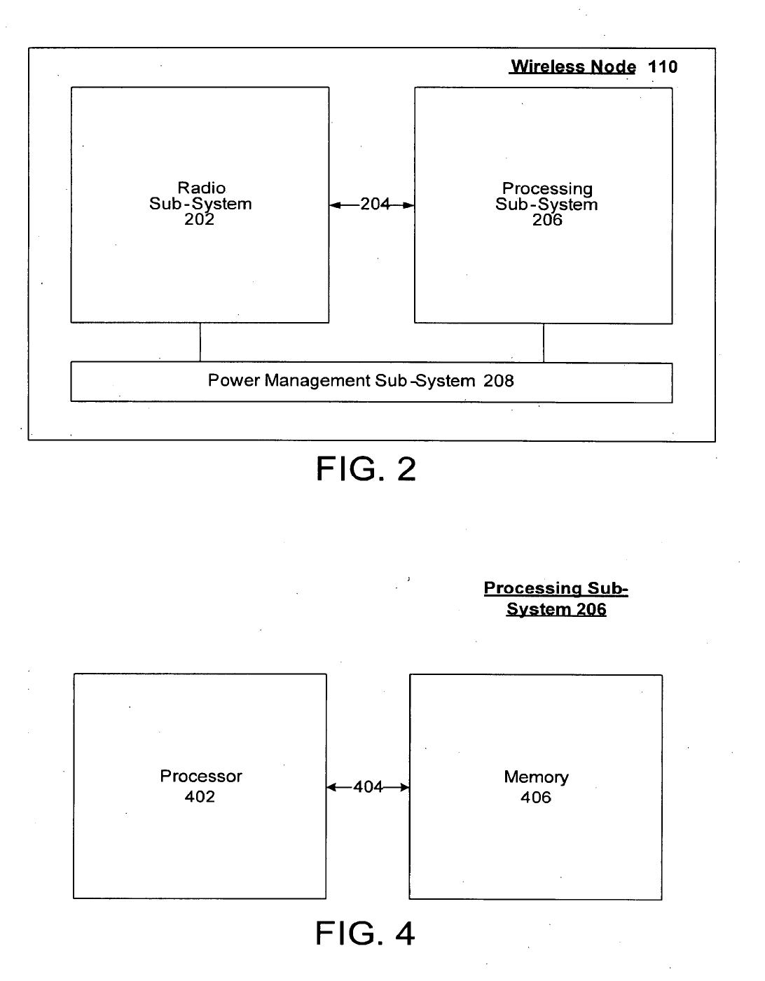

FIG. 2 illustrates one embodiment of a node. FIG. 2 illustrates a more detailed block diagram of mobile computing device 110 as described with reference to FIG. 1. As shown in FIG. 2, mobile computing device 110 may comprise multiple elements. Although FIG. 2 shows a limited number of elements in a certain topology by way of example, it can be appreciated that additional or fewer elements in any suitable topology may be used in mobile computing device 110 as desired for a given implementation. Furthermore, any element as described herein may be implemented using hardware, software, or a combination of both, as previously described with reference to node implementations. The embodiments are not limited in this context.

In various embodiments, mobile computing device 110 may include a radio sub-system 202 connected via bus 204 to a processing sub-system 206. Radio sub-system 202 may perform voice and data communications operations using wireless shared media 122-1 for mobile computing device 110. Processing sub-system 206 may execute software for mobile computing device 110. Bus 204 may comprise a USB or micro-USB bus and appropriate interfaces, as well as others.

In various embodiments, mobile computing device 110 also may include a power management sub-system 208. Power management sub-system 208 may manage power for mobile computing device 110, including radio sub-system 202, processing sub-system 206, and other elements of mobile computing device 110. For example, power management sub-system 208 may include one or more batteries to provide direct current (DC) power, and one or more alternating current (AC) interfaces to draw power from a standard AC main power supply. The embodiments are not limited in this context.

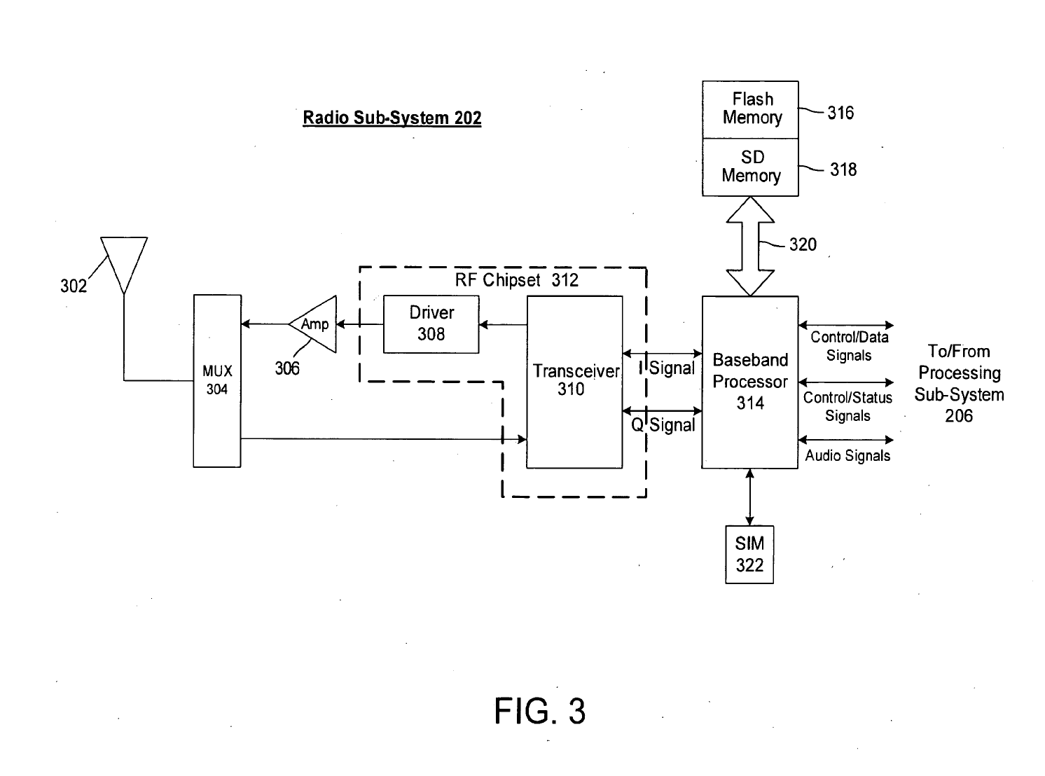

FIG. 3 illustrates one embodiment a radio sub-system. FIG. 3 illustrates a more detailed block diagram of radio sub-system 202 as described with reference to FIG. 2. Radio sub-system 202 may perform voice and data communication operations for mobile computing device 110. For example, radio sub-system 202 may be arranged to communicate voice information and control information over one or more assigned frequency bands of wireless shared media 122-1. The embodiments are not meant to be limited, however, to the example given in FIG. 3.

In various embodiments, radio sub-system 202 may include an antenna 302. Antenna 302 may broadcast and receive RF energy over wireless shared media 122-1. Examples for antenna 302 may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. The embodiments are not limited in this context.

In various embodiments, antenna 302 may be connected to a multiplexer 304. Multiplexer 304 multiplexes signals from power amplifier 306 for delivery to antenna 302. Multiplexer 304 demultiplexes signals received from antenna 302 for delivery to RF chipset 312. The embodiments are not limited in this context.

In various embodiments, multiplexer 304 may be connected to a power amplifier 306. Power amplifier 306 may be used to amplify any signals to be transmitted over wireless shared media 122-1. Power amplifier 306 may work in all assigned frequency bands, such as 4 frequency bands in a quad-band system. Power amplifier 306 also may operate in various modulation modes, such as Gaussian Minimum Shift Keying (GMSK) modulation suitable for GSM systems and 8-ary Phase Shift Keying (8-PSK) modulation suitable for EDGE systems. The embodiments are not limited in this context.

In various embodiments, power amplifier 306 may be connected to an RF chipset 312. RF chipset 312 also may be connected to multiplexer 304. In one embodiment, RF chipset 312 may comprise an RF driver 308 and an RF transceiver 310. RF chipset 312 performs all of the modulation and direct conversion operations required for GMSK and 8-PSK signal types for quad-band E-GPRS radio. RF chipset 312 receives analog in-phase (I) and quadrature (Q) signals from a baseband processor 314, and converts them to an RF signal suitable for amplification by power amplifier 306. Similarly, RF chipset 312 converts the signals received from wireless shared media 122-1 via antenna 302 and multiplexer 304 to analog I & Q signals to be sent to baseband processor 314. Although RF chipset 312 uses two chips by way of example, it may be appreciated that RF chipset 312 may be implemented using more or less chips and still fall within the intended scope of the embodiments. The embodiments are not limited in this context.

In various embodiments, RF chipset 312 may be connected to baseband processor 314. Baseband processor 314 may perform baseband operations for radio sub-system 202. Baseband processor 314 may comprise both analog and digital baseband sections. The analog baseband section includes I & Q filters, analog-to-digital converters, digital-to-analog converters, audio circuits, and other circuits. The digital baseband section may include one or more encoders, decoders, equalizers/demodulators, GMSK modulators, GPRS ciphers, transceiver controls, automatic frequency control (AFC), automatic gain control (AGC), power amplifier (PA) ramp control, and other circuits. The embodiments are not limited in this context.

In various embodiments, baseband processor 314 also may be connected to one or more memory units via a memory bus 320. In one embodiment, for example, baseband processor 314 may be connected to a flash memory unit 316 and a secure digital (SD) memory unit 318. Memory units 316, 318 may be removable or non-removable memory. In one embodiment, for example, baseband processor 314 may use approximately 1.6 megabytes of static read-only memory (SRAM) for E-GPRS and other protocol stack needs.

In various embodiments, baseband processor 314 also may be connected to a subscriber identity module (SIM) 322. Baseband processor 314 may have a SIM interface for SIM 322. SIM 322 may comprise a smart card that encrypts voice and data transmissions and stores data about the specific user so that the user can be identified and authenticated to the network supplying voice or data communications. SIM 322 also may store data such as personal phone settings specific to the user and phone numbers. SIM 322 can be removable or non-removable. The embodiments are not limited in this context.

In various embodiments, baseband processor 314 may further include various interfaces for communicating with a host processor of processing sub-system 206. For example, baseband processor 314 may have one or more universal asynchronous receiver-transmitter (UART) interfaces, one or more control/status lines to the host processor, one or more control/data lines to the host processor, and one or more audio lines to communicate audio signals to an audio sub-system of processing sub-system 206. The embodiments are not limited in this context.

FIG. 4 illustrates one embodiment a processing sub-system. FIG. 4 illustrates a more detailed block diagram of processing sub-system 206 as described with reference to FIG. 2. Processing sub-system 206 may provide computing or processing operations for mobile computing device 110. For example, processing sub-system 206 may be arranged to execute various software programs for mobile computing device 110. Although processing sub-system 206 may be used to implement operations for the various embodiments as software executed by a processor, it may be appreciated that the operations performed by processing sub-system 206 also may be implemented using hardware circuits or structures, or a combination of hardware and software, as desired for a particular implementation. The embodiments are not limited in this context.

In various embodiments, processing sub-system 206 may include processor 402. Processor 402 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, processor 402 may be implemented as a general purpose processor, such as a processor made by Intel® Corporation, Santa Clara, Calif. Processor 402 also may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments, however, are not limited in this context.

In one embodiment, processing sub-system 206 may include memory 406 to connect to processor 402. Memory 406 may be implemented using any machine-readable or computer-readable media capable of storing data, including both volatile and non-volatile memory. For example, memory 406 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 406 may be included on the same integrated circuit as processor 402 thereby obviating the need for memory bus 404. Alternatively some portion or all of memory 406 may be disposed on an integrated circuit or other medium, for example a hard disk drive, that is external to the integrated circuit of processor 402, and processor 402 may access memory 406 via memory bus 404. The embodiments are not limited in this context.

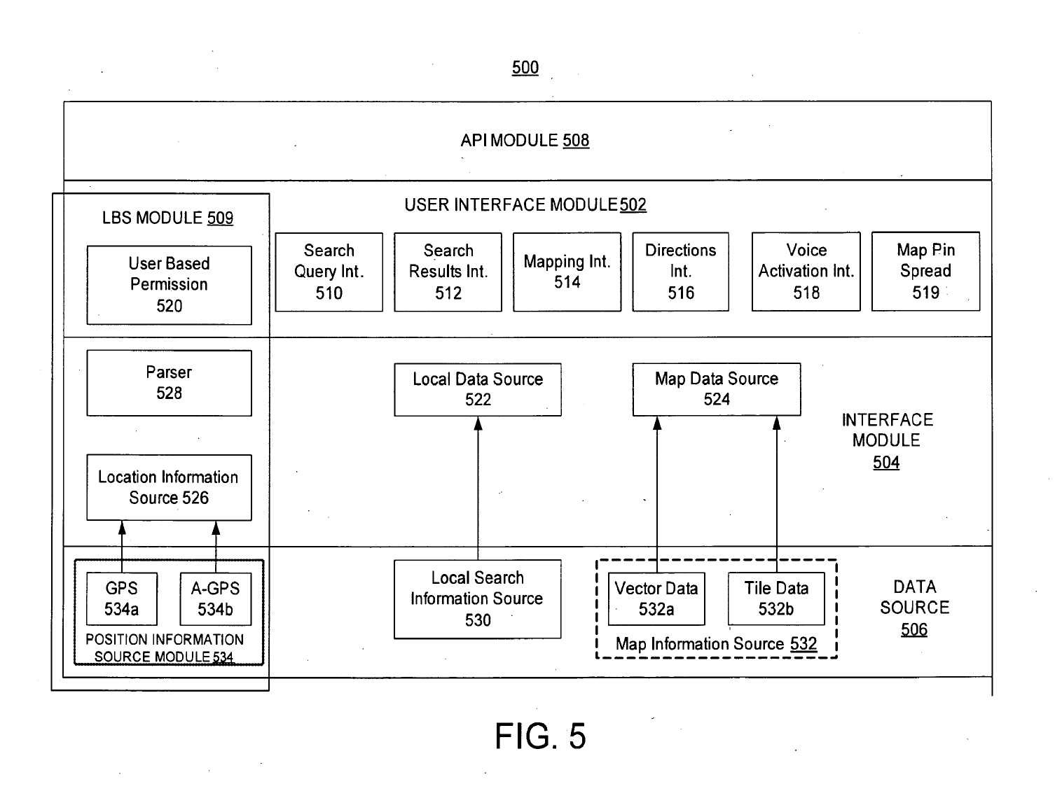

In various embodiments, memory 406 may store one or more software components (e.g., application client modules). A software component may refer to one or more programs, or a portion of a program, used to implement a discrete set of operations. A collection of software components for a given device may be collectively referred to as a software architecture or application framework. An example of a software architecture for mobile computing device 110 may be described in more detail with reference to FIG. 5.

FIG. 5 illustrates one embodiment of a software architecture. FIG. 5 illustrates a software architecture 500 suitable for use with mobile computing device 110. As shown in FIG. 5, software architecture 500 may include user interface (UI) module 502, interface module 504, data source or backend services module 506 (data source 506), and third party API module 508. Optional LBS module 509 may comprise user based permission module 520, parser module 528 (e.g., National Maritime Electronic Association or NMEA), location information source module 526, and position information source module 534. The software components shown in FIG. 5 are representative of some of the software components comprising software architecture 500. In some embodiments, some software components may be omitted and others added. Further, operations for some programs may be separated into additional software components, or consolidated into fewer software components, as desired for a given implementation. Software architecture 500 may comprise several elements, components or modules, collectively referred to herein as a “module.” A module may be implemented as a circuit, an integrated circuit, an application specific integrated circuit (ASIC), an integrated circuit array, a chipset comprising an integrated circuit or an integrated circuit array, a logic circuit, a memory, an element of an integrated circuit array or a chipset, a stacked integrated circuit array, a processor, a digital signal processor, a programmable logic device, code, firmware, software, and any combination thereof. The embodiments are not limited in this context.

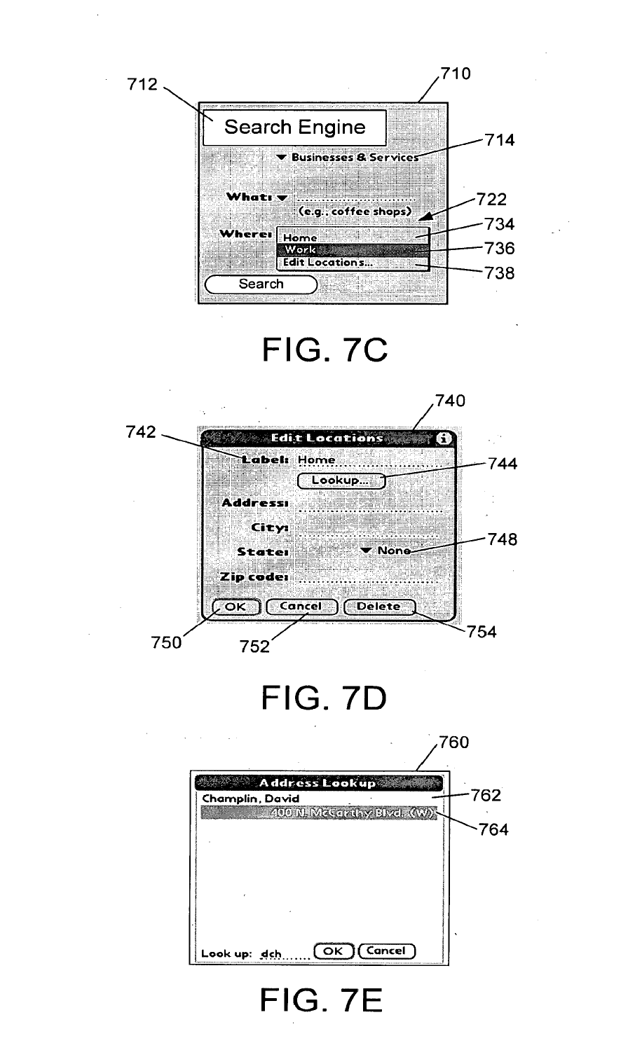

In various embodiments, software architecture 500 may include UI module 502. In one embodiment, UI module 502 may include search query interface module 510, search results interface module 512, map interface module 514, directions interface module 516, voice activated interface module 518, map pin spread module 519, and user based permission module 520, for example. Search query interface module 510 enables a user to submit a query to a search engine. For example, search query interface module 510 provides a search query interface to enable a user to enter a query into mobile computing device 110 to perform a local search for a particular entity located in a geographic region. For example, search query interface module 510 enables mobile computing device 110 to perform a search for a local coffee shop (e.g., Starbucks®) in a nearby geographic region (e.g., “Sunnyvale, Calif.”), for example. Search query interface module 510 is described in further detail below with reference to FIGS. 7A-E, for example. Search results interface module 512 displays the results of the search performed via search query interface module 510. The search results may be displayed on a local interface provided by mobile computing device 110 rather than on a browser interface. This improves the readability and display of the search results in any format specification and enables a user to take certain actions based on the search results. Map interface module 514 provides a native OS map interface. The native OS map interface module 514 provides zooming and panning functionality and also provides other information to the user. Directions interface module 516 displays user requested directions from point A to point B in an intuitive, easy to read manner. Voice activated interface module 518 enables the user to navigate using voice prompts. Voice activated interface module 518 may be integrated to process location information available through an onboard or accessory based GPS, for example. If a GPS device is provided onboard, for example, integrated with or located in the same housing 102 as mobile computing device 110, mobile computing device 110 may require user based permission module 520 to manage which client application modules may access location information and to define any parameters associated with the location information. Map pin spread module 519 causes map pins overlaid on a bitmap map image to move so that they do not overlap or obstruct each other, or obstruct a point of interest to the user on the map. Map pin spread module 519 causes the overlaid map pins to act as though they repel each other and rearrange themselves so that they do not overlap or obstruct each other or the point of interest on the map. The embodiments are not limited in this context.

In various embodiments, software architecture 500 may include interface module 504. Interface module 504 may be referred to as an abstraction layer to enable communication between UI module 502 and data source 506. Interface module 504 provides the interface processing to enable UI module 502 to communicate with the various data sources or backend services (e.g., servers 132-1-n over network 130). Interface module 504 sends and receives information to and from data source 506 and receives information to and from UI interface module 502. Because data source 506 may vary, interface module 504 communicates with UI module 502 to provide a uniform interface and experience to a user via display 104. Therefore, interface module 504 may be referred to an abstraction layer to process the variation in the data sources or backend services data and provides a substantially uniform interface and experience to the user. Interface module 504 includes local data source module 522, map data source module 524, location information source module 526, and parser module 528. Local data source module 522 transfers user input such as search terms for a local entity (e.g., location of nearest “Starbucks in Sunnyvale, Calif.”) from search query interface module 510 to data source 506 backend services and presents the local search results to search results interface module 512. Map data source module 524 communicates to various data sources and backend services, such as, mapping services, and makes the maps usable on mobile computing device 110 via map interface module 514. Location information source module 526 provides location information to the various client application modules of mobile computing device 110 in a uniform standard manner irrespective of the underlying technology (e.g., GPS inbuilt, accessory, AGPS, etc.). In one embodiment, parser module 528 may be adapted to convert NMEA standard location data stream received from navigation equipment (e.g., GPS receivers) conforming to the NMEA 0182 Version 2.0 specification into latitude and longitude. In one embodiment, parser module 528 may be combined with location information source module 526 as an integral unit. The embodiments are not limited in this context.

In various embodiments, software architecture 500 may include data source 506, which also may be referred to herein as a backend service provided via network 130 through servers 132-1-n. It will be appreciated that the terms “data source” and “backend service” may be used interchangeably herein. In one embodiment, data source 506 may refer to data providers previously described. Such data providers may include, for example, local search information source 530, map information source 532, and GPS information source module 534. Local search information source 530 may provide yellow pages type of information and may include third party search engines such as GOOGLE™ and YAHOO®, among others previously described, for example. Yellow pages type of information may include, for example, name, address, phone number, and other data associated with an entity. Map information source 532 may provide raw map information in many forms. In one embodiment, the raw map information may be provided as vector data 532a (e.g., NAVTEQ, TELEATLAS, among others) to local data source module 522. In one embodiment, the raw map information may be provided as tile data 532b (e.g., GOOGLE™, NAVTEQ, TELEATLAS, among others) to map data source module 524. In one embodiment, interface module 504 provides a uniform interface display of the information received from data source 506 regardless of the backend service that provides the information. Thus, the user can interact with a uniform interface that does not change substantially with respect to the provider of the information. In one embodiment, raw map information may be provided onboard mobile computing device 110. For example, raw map information may be provided on a secure digital (SD) memory card or the like. Position information source module 534 may comprise either an onboard GPS position information source module 534a or an A-GPS position information source module 534b using carrier networks or any combination thereof. In one embodiment, position information source 534 may be implemented with any number of available GPS accessories, for example. The embodiments are not limited in this context.

In various embodiments, software architecture 500 may include third party API module 508. In one embodiment, for example, third party API module 508 may comprise one or more application client programs, such as groupware programs, for example. More particularly, third party API module 508 may comprise application clients for mobile computing device 110 to access third party information on servers 132-1-n via network 130. In one embodiment, the application clients may access third party API module 508 and retrieve geographic coordinates and map interfaces, queries or search engines, interfaces to third party LBSs, and the like. Third party API module 508 may communicate messages with other nodes of system 100 via one or more application servers 132-1-n. Application clients and/or an operating system (OS) for mobile computing device 110 may include a user interface to display information and receive information to and from a user. The embodiments are not limited in this context.

In one embodiment, software architecture 500 may be integrated with third party software applications via third party API module 508. Accordingly, third party software developers may provide software applications that integrate with the platform provided by software architecture 500. For example, in various embodiments, third party software applications may include API access to search results interface module 512 of UI module 502. Therefore, query results from third party applications may be displayed in a substantially similar uniform manner as the local search results provided by local data source module 522. In addition, third party software applications may include API access to map interface module 514. Accordingly, third party software applications can overlay information content on map information provided by map data source module 524, for example. Furthermore, third party software applications may include API access to location API. Provided that the third party software application contains the requisite approval, it may access the location information contained in computing device 110, i.e., latitude/longitude, in a similar manner to that provided by location information source module 526. An example of a third party API module 508 application may include conducting user searches for events such as “open homes” in a predetermined geographic region. The results of the search may include, for example, open homes information overlaid on a map with additional available information such as price, size, number of rooms, and so on. Another example includes determining traffic conditions. A user may want to look at traffic conditions on a predetermined highway between two geographic locations. This traffic information may be overlaid on a map with enhanced information such as traffic speed, accident information, alternate routes, and so on. The embodiments are not limited in this context.

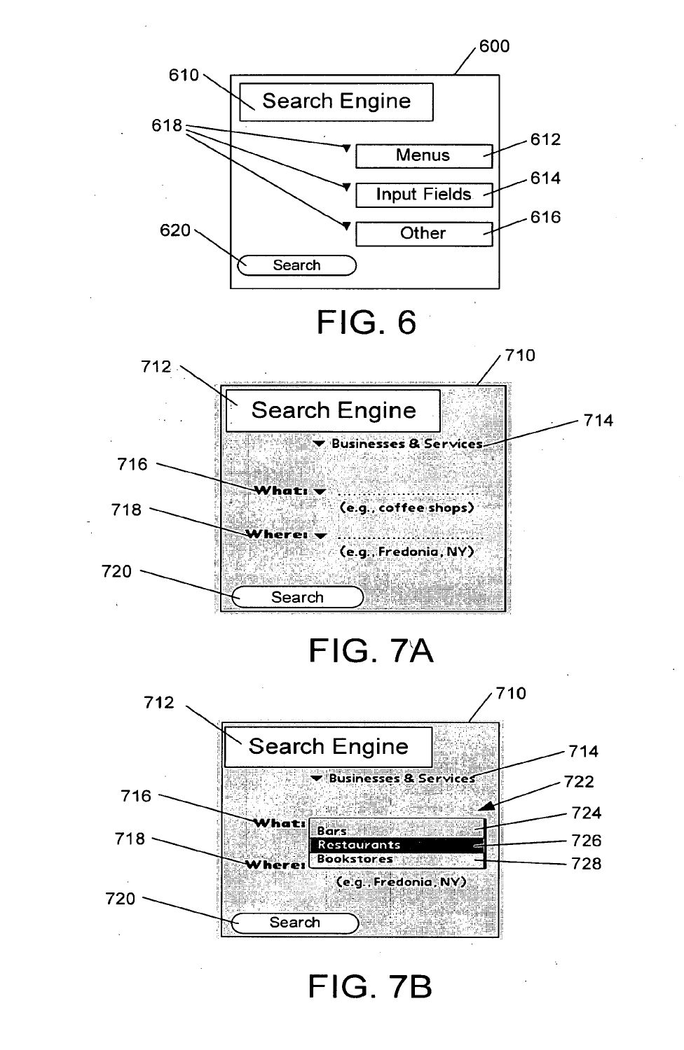

FIG. 6 illustrates one embodiment of a UI screen. FIG. 6 illustrates UI screen 600 that provides one or more menus 612, input fields 614, and other interfaces 616. Any one of or each of menus 612, input fields 614, and other interfaces 616 may be expanded via pop-up tabs 618. UI screen 600 may be linked to an underlying search engine 610, which may be launched via search button 620.

As previously discussed, search query interface module 510 enables a user to query local search information source 530 through local data source module 522. Search query interface module 510 provides a base uniform display layout format including a screen with menus and navigation options to a user regardless of the specific local search information source 530 being used. FIGS. 7A-E illustrate various embodiments of a display layout format including screens, menus, and navigation options presented to the user by search query interface module 510.

FIG. 7A illustrates one embodiment of a screen. FIG. 7A illustrates one embodiment of base screen 710 that represents one embodiment of a default view provided by search query interface module 510 when it is invoked. In one embodiment, base screen 710 displays the name of underlying search engine 712 associated with local search information source 530. In one embodiment, for example, underlying search engine 712 may be GOOGLE™, or any other suitable search engine. Other local search information sources 530 may be displayed. Base screen 710 may include pop-up 714 and associated input fields 716, 718, among others, for example. An example of the type of text a user may enter in “What” input field 716 is the subject “coffee shops,” among others. An example of the type of text a user may enter in “Where” input field 718 is the subject “Fredonia, N.Y.,” among other geographic locations where the user is searching for “coffee shops” entered in “What” input field 718. Base screen 710 also may include search engine button 720 to launch the underlying search engine application associated with local search information source 530, e.g., “GOOGLE™ Search.” In one embodiment, pop-up 714 may include, for example, a “Businesses & Services” pop-up, which may be a yellow pages/directions type of pop-up. Alternative pop-ups may include other types of queries such as movies, directions, maps, world-wide-web search interface, and similar services. Any pop-up 714 may include viewable tabs. “What” and “Where” input fields 716, 718 can operate as local search boxes for the underlying search engine of local search information source 530. For example, input fields 716, 718 may operate in a manner similar to GOOGLE™ Local on a desktop computer browser. In one embodiment, “What” input field 716 may be designated as a default focus field, although other variations are within the scope of the embodiments. In one embodiment, results displayed on base screen 710 may be preserved such that if the user exits pop-up 714 the original results may be displayed when the user reenters pop-up 714 at a later time. This may apply to any pop-up 714, such as, movies, directions, maps, world-wide-web search interface, and other similar services associated with pop-up 714. Also, if the user has entered text in respective “What” and “Where” input fields 716, 718 and then leaves base screen 710, the entered text may be stored, erased or highlighted and is made available when the user returns to base screen 710. The embodiments are not limited in this context.

FIG. 7B illustrates one embodiment of a screen. FIG. 7B illustrates one embodiment of base screen 710 displaying history list 722 of text entries made by the user in “What” input field 716. History list 722 may comprise multiple entries such as bars 724, restaurants 726, and bookstores 728, which may be categorized in any suitable manner. For example, bars 724, restaurants 726, and bookstores 728 may be categorized based on time from most recent entry to oldest entry or vice versa. The number of entries in history list 722 may be limited to a maximum number N, such that the first or oldest entry rolls off history list 722 when the (N+1)^{th} entry is made. For example, if N=10 and history list 722 is set to hold ten entries, the first, or oldest entry, rolls off the list, when the 11^{th} entry is entered by the user. The user may highlight an entry displayed in history list 722, e.g., restaurants 726 in the illustrated embodiment, to select and launch the pop-up associated with the text entry. In one embodiment, the user may save history list 722 to memory 406. The embodiments are not limited in this context.

FIG. 7C illustrates one embodiment of a screen. FIG. 7C illustrates one embodiment of base screen 710 displaying a list of categories 732 of entries that the user entered in the “Where” input field 718 and saved to memory 406, for example. The list of categories 732 may include, for example, “Home” field 734, “Work” field 736, and “Edit Locations” field 738, among others. In one embodiment, an entry made in the “Where” field may be saved to memory 406 such that the entry may be used to pre-fill “Where” input field 718, for example. The embodiments are not limited in this context.

FIG. 7D illustrates one embodiment of a dialog screen. FIG. 7D illustrates on embodiment of an “Edit Locations” dialog screen 740 associated with “Edit Locations” field 738 in “Where” input field 718. “Edit locations” dialog screen 740 includes a label field 742 that may be associated with “Home” field 734, “Work” field 736 or any fields associated with “Where” input field 718. In the illustrated embodiment, label field 742 is associated with “Home” field 734. Selecting “Lookup” button 744 invokes an “Address Lookup” dialog screen 760, described below with reference to FIG. 7E. “Edit Locations” dialog screen 740 may include Address, City, State, and Zip fields collectively referred to as address fields 746. The State field portion of address fields 746 includes pop-up 748 to enable the user to select any one of the United States or none. A series of buttons is provided to complete a transaction with “Edit Locations” dialog screen 740. For example, “OK” button 750 accepts and stores the current entries, “Cancel” button 752 abandons any current entries provided in the “Edit Locations” dialog screen 740 fields, and “Delete” button 754 removes a current location from the list. It will be appreciated that any or all of the fields in “Edit Locations” dialog screen 740 may be optional. Furthermore, other implementations of “Edit Locations” dialog screen 740 may be provided without departing from the scope of the embodiments.

FIG. 7E illustrates one embodiment of a dialog screen. FIG. 7E illustrates one embodiment of an “Address Lookup” dialog screen 760 that may be displayed when “Lookup” button 744 is selected in “Edit Locations” dialog screen 740. Accordingly, name field 762 and address field 764 is displayed. Address filed 764 may include multiple optional addresses such as work, home or other. In the illustrated embodiment, the work address is shown as indicated by a “(W)” located after the address text. A home address may be shown with “(H)” next to the address. The embodiments are not limited in this context.

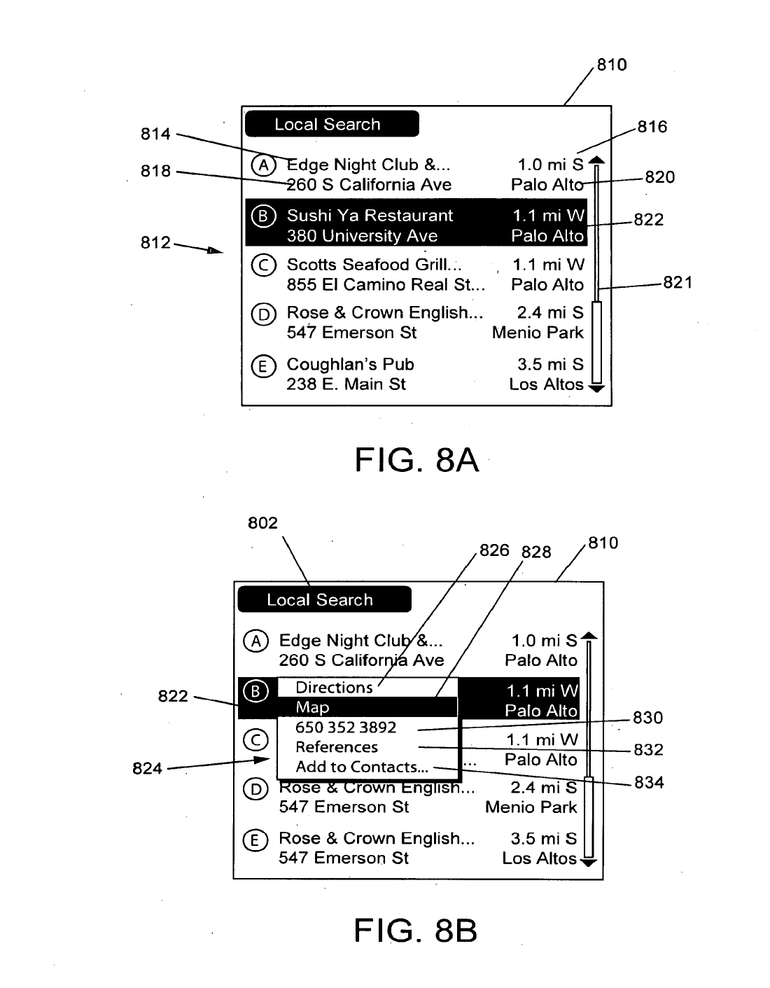

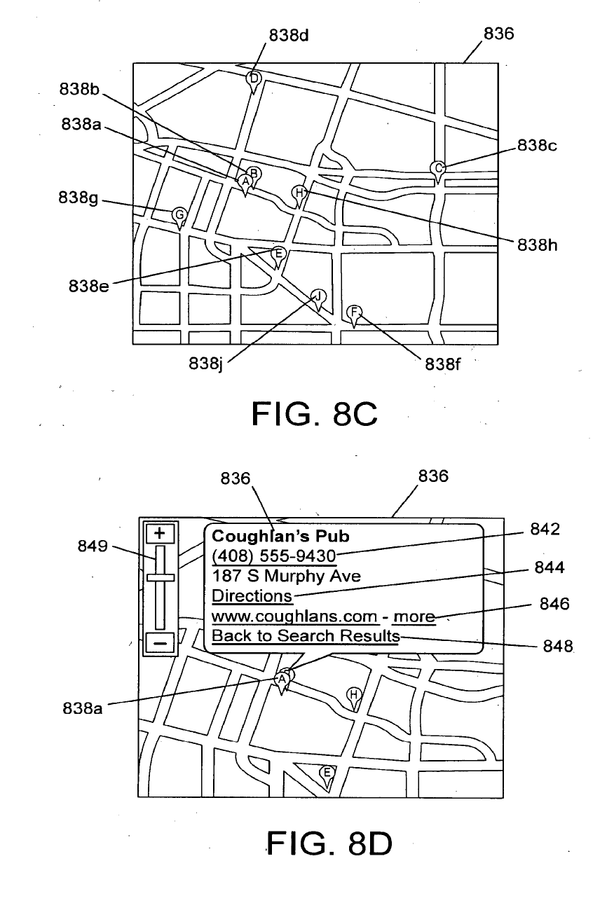

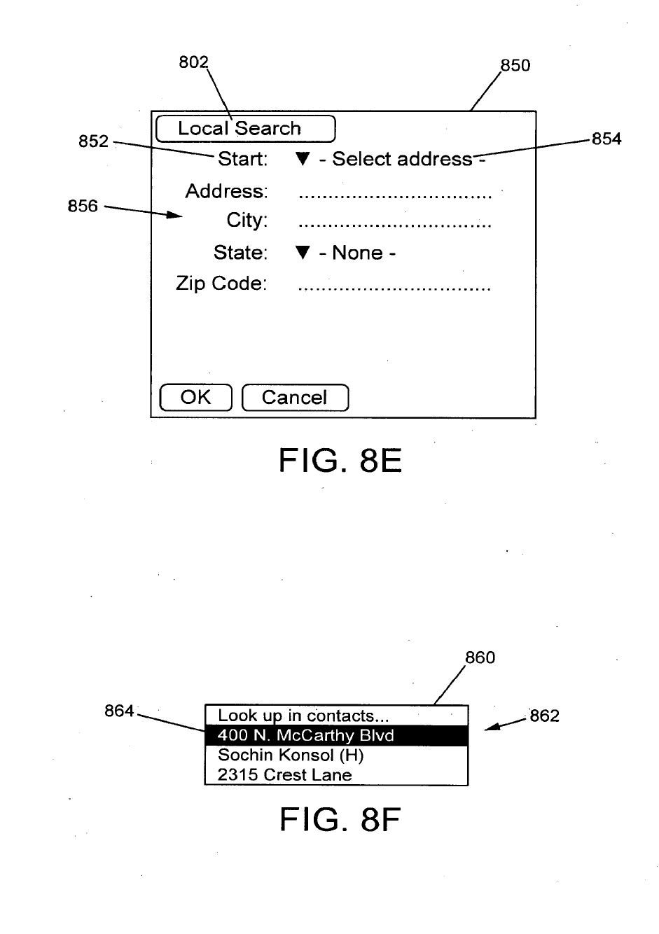

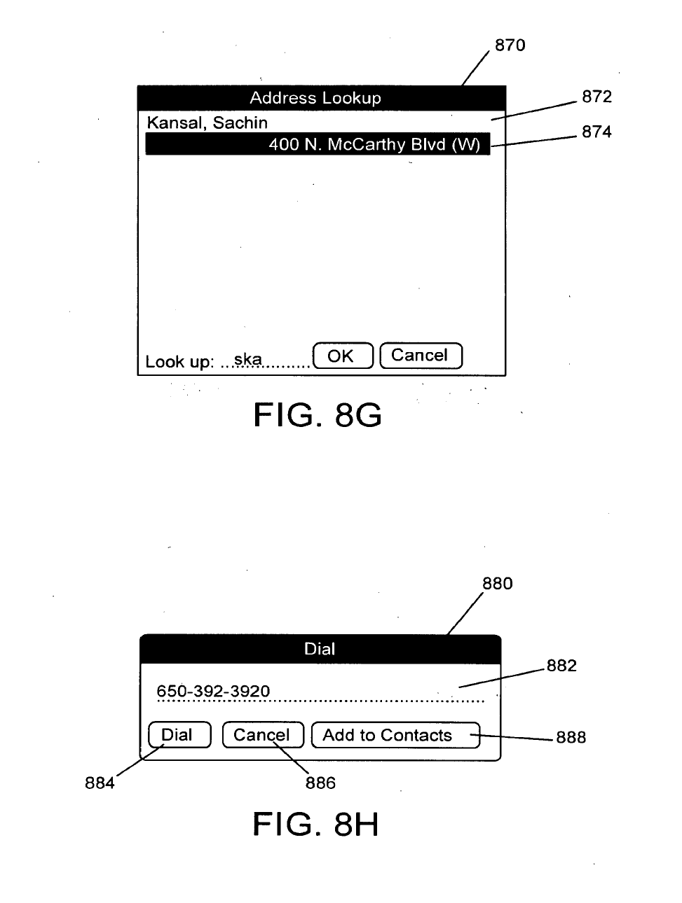

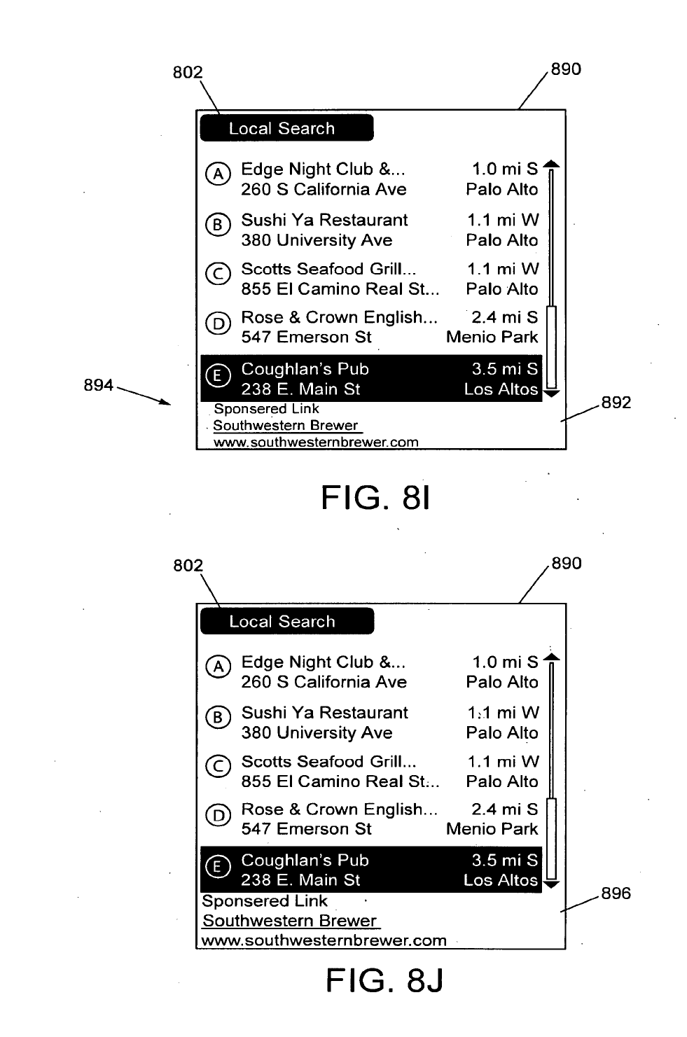

FIGS. 8A-I illustrate various embodiments of a search results interface. FIGS. 8A-I illustrate various embodiments of search results interface module 512 layout and advertisements presented to the user. As previously discussed, search results interface module 512 enables a user to conduct a search using a local interface rather than a browser interface, for example. This enables readability and uniform display of the search results provided to search results interface module 512 in any format specification and allows the user to take certain actions based on the results. Search results interface module 512 provides a base layout screen format including menus and navigation options to a user.

FIG. 8A illustrates a basic search results screen. FIG. 8A illustrates a search results screen 810 provided by search results interface module 512 listing the search results returned by query interface module 510 based on local search engine 802. Search result items 812 may be displayed in a scrolling list above a map (not shown). Search result items 812 may be identified by labels A, B, C, D, E, and so on. For each result returned by local search engine 802, a first line contains the name of entity 814 justified left and the distance and directions 816 to entity 814 from the current location of mobile computing device 110 justified right. A second line contains address 818 of entity 814 justified left and city 820 in which entity 814 is located justified right. In the illustrated embodiment, five search result items 812 are listed on page 1 and are indexed A, B, C, D, and E. Items 812 on a current page may be scrolled using scroll bar 821, for example. Additional search result items 812 may be displayed on a page by page basis, for example. If search result items 812 span several pages, a user interface may be provided at the bottom of search result items 812 list to go to those pages. Display options may be provided for each one of search result items 812. These options may be accessed or displayed by highlighting the item of interest on the list. To view the options associated with a particular search result item 812, that item may be highlighted and a predetermined action may betaken with mobile computing device 110. In the illustrated embodiment, selected item 822 (B) is highlighted. Subsequent actions may be referenced back to selected search result items 812. The embodiments are not limited in this context.

FIG. 8B illustrates a search results screen. FIG. 8B illustrates search results screen 810 with an options pop-up display 824 associated with selected item 822. In the illustrated embodiment, options pop-up display 824 provides options associated with selected item 822 from search result items 812 listed in search results screen 810. Options pop-up display 824 may display several options of actions that the user may take with respect to selected item 822. These options may include, for example, directions 826, map 828, telephone number 830, references 832, and add to contacts 834, among others. In the illustrated embodiment, map 828 option is highlighted to display a map associated with selected item 822. The embodiments are not limited in this context.

FIG. 8C illustrates one embodiment of a map. FIG. 8C illustrates one embodiment of a map 836 that is displayed when the user selects map 828 option field in options pop-up display 824. Map 836 may be displayed at various zoom levels. In one embodiment, an I/O device 106 element may be activated to drill down on map 836. For example, as the user drills down, map 836 may be displayed from a general high level zoom to a more detailed level zoom. Labeled map pins 838 may be overlaid on map 836 to mark the location of search result items 812 listed in search results screen 810. It will be appreciated that only map pins 838 located within the current zoomed geographic region of map 836 as displayed. For example, in the illustrated zoom state display of map 836, search result items are overlaid on map 836 in the form of labeled map pins 838a, b, c, d, e, f, g, h, and j because they are geographically located within the currently displayed region of map 836. Map pin 838b overlaps map pin 838a. Thus, map pin 838b is obstructed by map pin 838a. It will be appreciated that fewer map pins 838 are displayed as map 836 is continually zoomed down to a more detailed view. All map pins 838 may be viewed if map 836 is zoomed out sufficiently. At any desired zoom level, the user can pan map 836. In addition, the various map pins 838 move under the control of map pin spread module 519 described below if they obstruct each other or if the intended view of a location on map 836 is obstructed by map pins 838. For example, map pin spread module 519 causes map pins 838 to act as though they repel each other and spread-out. This action provides the user with a clear unobstructed view of all the map pins overlaid on map 836. This also provides a clearer view of the location of point of interest. The embodiments are not limited in this context.

FIG. 8D illustrates one embodiment of a map. FIG. 8D illustrates one embodiment of map 836 at a predetermined zoom/pan display state. Map 836 includes a pop-up display 840 overlaid thereon. Pop-up display 840 provides additional information associated with the selected map pin 838a, which represents item “A” listed in search results screen 810. The information listed in pop-up display 840 may provide items of information associated with the entity or establishment located at the point indicated by the selected map pin 838a. For example, in the illustrated embodiment, pop-up display 840 information associated with the establishment includes the name of the establishment (e.g., “Coughlan's Pub”) of selected item 822, phone number 842 (e.g., “(408) 555-9430”), address (e.g., “187 S Murphy Ave”), directions 844, and web site link 846. The user can return to search results screen 810 by selecting back to search results link 848 (e.g., “Back to Search Results”). Items in pop-up display 840 that are underlined, such as text, phone number 842, directions 844, web site link 846, and back to search results link 848 are hotlinks to enable the user to launch related application programs. These programs execute code to automatically dial phone number 842 (e.g., “(408) 555-9430”), get directions 844 to address (e.g., “187 S Murphy Ave”), go to web site link 846 of the entity, go back to search results link 848, and the like. It will be appreciated that pop-up display 840 may include additional or fewer items without departing from the scope of the embodiments. Scroll bar 849 may be used to display additional information associated with selected item 822 (e.g., map pin 838a) that does not fit within the dimensions of pop-up display 840. The embodiments are not limited in this context.

FIG. 8E illustrates one embodiment of a directions display screen. FIG. 8E illustrates one embodiment of directions display screen 850 that is displayed when the user selects either directions 826 in options pop-up display 824 or directions 844 link in pop-up display 840. Directions display screen 850 may include the starting address reference point for the directions in “Start” field 852. The starting address reference point may be selected from a “Select address” pop-up 854 or may be entered in the appropriate address fields 856. It may be assumed that the destination address is associated with selected item 822. In one embodiment, the user may be given an option to enter the destination address in directions display screen 850. The embodiments are not limited in this context.

FIG. 8F illustrates one embodiment of a contacts list pop-up screen. FIG. 8F illustrates one embodiment of contacts list pop-up screen 860 that is displayed when the user selects “Select address” pop-up 854. Contacts list pop-up screen 860 may include addresses previously entered by the user in address list 862. Address item 864 may be selected from address list 862. The contacts in address list 862 may be categorized and/or displayed as an historical list or as a managed list. A historical list includes contacts listed in the order of most recently accessed. A managed list of contacts may employ some form of edit functionality to enable the user to add, delete or otherwise modify the list of contacts. The embodiments are not limited in this context.

FIG. 8G illustrates one embodiment of an address lookup screen. FIG. 8G illustrates one embodiment of address lookup screen 870. Address lookup screen 870 displays name 872 and address 874 of selected address item 864 in address list 862. The embodiments are not limited in this context.

FIG. 8H illustrates one embodiment of a dial screen. FIG. 8H illustrates one embodiment of dial screen 880. Dial screen 880 is displayed when the user selects telephone number 830 in options pop-up display 824 or directions 844 link in pop-up display 840. Telephone number 882 associated with selected item 822 is displayed in dial screen 880. The user may dial telephone number 882 by selecting “Dial” button 884. The user may cancel the transaction by selecting “Cancel” button 886. In addition, the user may choose to add telephone number 882 to the contacts list by selecting “Add to Contacts” button 888. The embodiments are not limited in this context.

FIG. 8I illustrates one embodiment of a basic search results screen. FIG. 8I illustrates one embodiment of search results screen 890 that includes advertisement 892 at bottom portion 894 of search results screen 890. In one embodiment, advertisement 892 may be a sponsored link that the user may launch. In one embodiment, advertisement 892 may include a hypertext to the home page of the advertiser's home page web site. The advertisement may be displayed in any suitable format. For example, text style and size may vary to accommodate the amount of advertisement content to be displayed at bottom portion 894 of search results screen 890. The embodiments are not limited in this context. FIG. 8J illustrates advertisement 896 in a larger style font than advertisement 892.

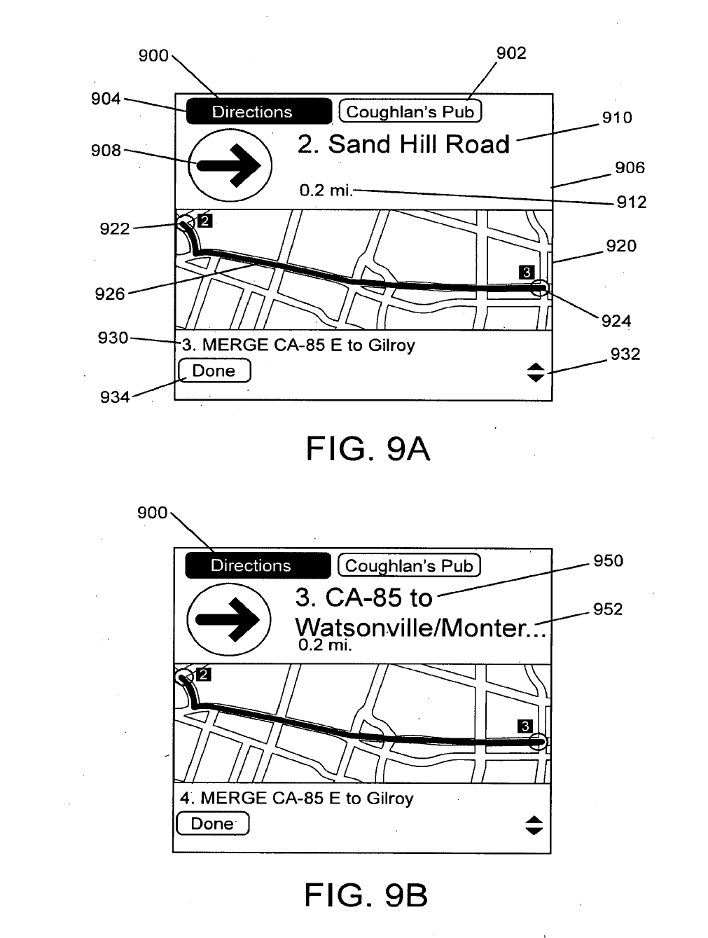

FIG. 9A illustrates one embodiment of a driving directions interface screen. FIG. 9A illustrates one embodiment of driving directions interface screen 900 displayed by directions interface module 516. As previously discussed, software architecture 500 provides directions interface module 516 to display user requested directions to selected item 822 from point A to point B in an intuitive, easy to read manner. The user may select the directions hotlink to invoke driving directions interface screen 900 from directions 826 options pop-up display 824 or directions 844 link in pop-up display 840. Once invoked, driving directions interface screen 900 displays the driving directions to selected item 822 location on a step-by-step basis.

Driving directions interface screen 900 displays destination location address 902 next to title tab 904 (e.g., “Directions”). Driving directions interface screen 900 includes next step portion 906. Next step portion 906 displays icon 908, next step instruction 910, and distance 912 to next step. In the illustrated embodiment, next step instruction 910 is step 2 “Sand Hill Road.” Next step instruction 910 may be displayed on one or more lines in any suitable format, such as a larger bold formatted font relative to other displayed text, for example. Icon 908 may comprise, an arrow, freeway indicator or other roadway sign. Icon 908 may indicate whether the next step is a turn left, turn right, merge left, merge right, freeway sign, ramp, exit, and/or start/end, for example. Driving directions interface screen 900 also may include map portion 920 including starting point 922 and destination point 924 along highlighted route 926. Next-next step 930 may be displayed below map portion 920. In the illustrated embodiment, next-next step 930 is step 3 “Merge CA-85 to Gilroy.” Next-next step 930 may be displayed in any suitable format, such as a smaller plain formatted font relative to other displayed text. The user may scroll the driving directions in a forward or reverse manner using UP/DOWN scroll indicator arrows 932, for example. LEFT/RIGHT scroll indicator arrows also may be provided as part of the driving direction interface. The user may select done button 934 to exit driving directions interface screen 900. Navigation in driving directions interface screen 900 may be implemented as a split focus model. The destination location may be shown in the center of map portion 920. The embodiments are not limited in this context.

FIG. 9B illustrates one embodiment of a driving directions interface screen. FIG. 9B illustrates one embodiment of driving directions interface screen 900 with abbreviation “to” 950 for the word “towards” to save space and make the text more readable for the user. Any overflow text 952 “CA-85 to Watsonville/Monterey” may be truncated to fit in the allocated space. The embodiments are not limited in this context.

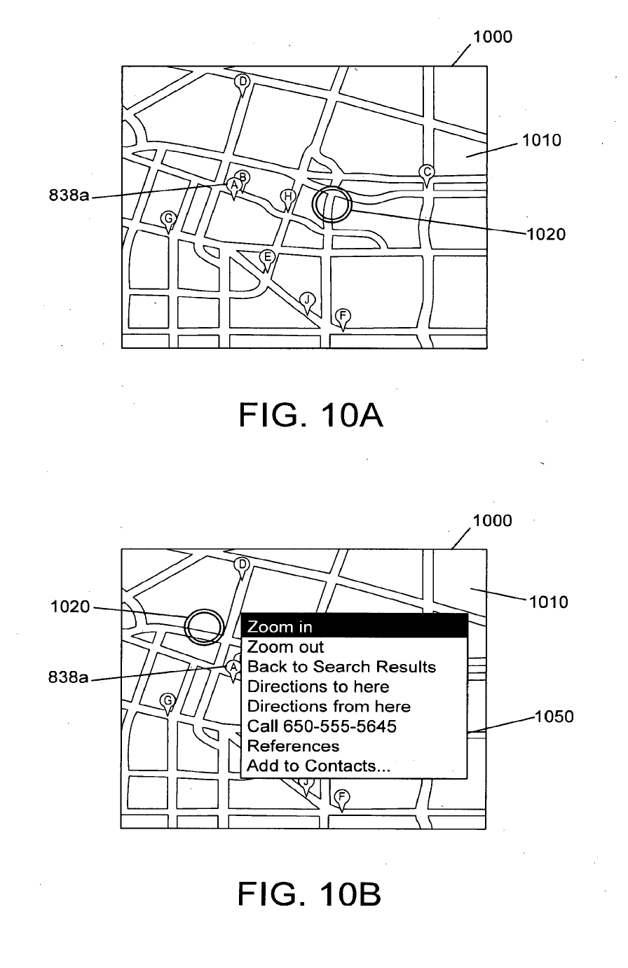

FIG. 10A illustrates one embodiment of a map interface screen. FIG. 10A illustrates one embodiment of map interface screen 1000 generated by map interface module 514. Map interface module 514 provides a native OS map interface for zooming and panning bitmap map 1010 and for providing other information to the user. Map 1010 displays one or more map pins 838a (among others) associated with search result items 812. Map 1010 also displays focus region 1020 to assist the user to navigate. Focus region 1020 may be moved up/down/left/right either on map 1010 or on an edge of map interface screen 1000. When focus region 1020 is provided on map interface screen 1000, map 1010 moves to that position. If focus region 1020 is on an edge of map interface screen 1000, then map 1010 pans in that direction. The embodiments are not limited in this context.

FIG. 10B illustrates one embodiment of a map interface screen. FIG. 10B illustrates one embodiment of map interface screen 1000 generated by map interface 514 with a pop-up menu 1050 displayed therein. If center of focus region 1020 is located over map pin 838a, then a full pop-up menu 1050 is displayed. Full pop-up menu 1050 includes options for the user to zoom-in, zoom-out, go back to search results, get directions to here (e.g., location of focus region 1020 or map pin 838a), get directions from here (e.g., location of focus region 1020 or map pin 838a), call the telephone number associated with a location (e.g., 650-503-5645), references, and/or add to contacts. If focus region 1020 is located between map pins, then pop-up menu 1050 displays only zoom-in and zoom-out options. The embodiments are not limited in this context.

Operations for the above embodiments may be further described with reference to the following figures and accompanying examples. Some of the figures may include a logic flow diagram. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

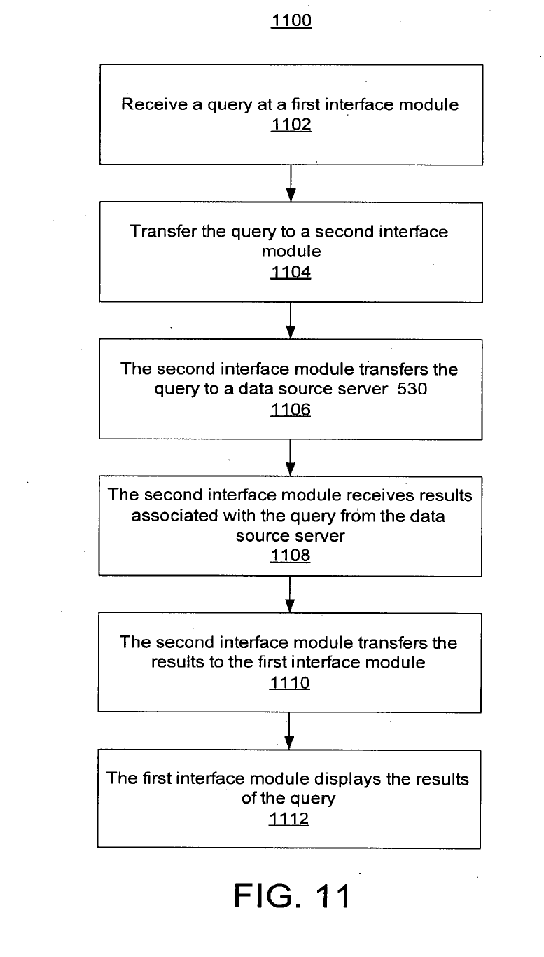

FIG. 11 illustrates one embodiment of a logic flow diagram. FIG. 11 illustrates one embodiment of logic flow diagram 1100. Logic flow diagram 1100 may be representative of the operations executed by one or more embodiments described herein, such as mobile computing device 110, application client modules associated with UI module 502, interface module 504, data source 506, and third party API module 508. Logic flow diagram 1100 may be representative of the operations executed by one or more embodiments described herein with reference to search query interface module 510, search results interface module 512, map interface module 514, directions interface module 516, voice activated interface module 518, pin spread module 519, user based permission module 520, local data source module 522, map data source module 524, location information source module 526, and parser module 528, for example. As shown in logic flow diagram 1100, first interface module 502 receives 1102 a query. The query is transferred 1104 to second interface module 504. Second interface module 504 transfers query 1106 to a server associated with local search information source 530, receives results 1108 associated with the query from the server and transfers results 1110 to first interface module 502. First interface module 502 displays results 1112 of the query. The results of the query include location information of at least one entity associated with the query.

In one embodiment, the query is received by search query interface module 510, the results are received by search results interface module 512, and the results are displayed in a predefined format. The query is received by local data source module 522 from search query interface module 510. The query is transferred to at least one web enabled search engine, such as, for example, local search information source 530, the results are received from local search information source 530, and are transferred to search results interface module 512. The embodiments are not limited in this context.

In one embodiment, the results are received from second interface module 506 by map interface module 514 and driving directions interface screen 900 is displayed based on the location information by map interface module 514. The query is received from search query interface module 510 by map data source module 524 and is transferred to backend mapping service 542. The mapping information is received from backend map information source 532 by map data source module 524 and is transferred to map interface module 514. The results are transferred from interface module 504 to directions interface module 516. Directions interface module 516 displays the directions on a step-by-step basis in accordance with the location information. The embodiments are not limited in this context.

The query may be transferred by location information source module 526 to position information source module 534. The position information is received from position information source module 534 and is transferred to interface module 502. The position information from position information source module 534 may be received by user based permission module 520. The position information may be transferred to a client application if the client application has permission to receive it. The position information received from position information source module 534 may be converted to latitude and longitude information. The voice activated directions may be transferred to voice activated interface module 518. The user can navigate according to the position information received from position information source module 534.

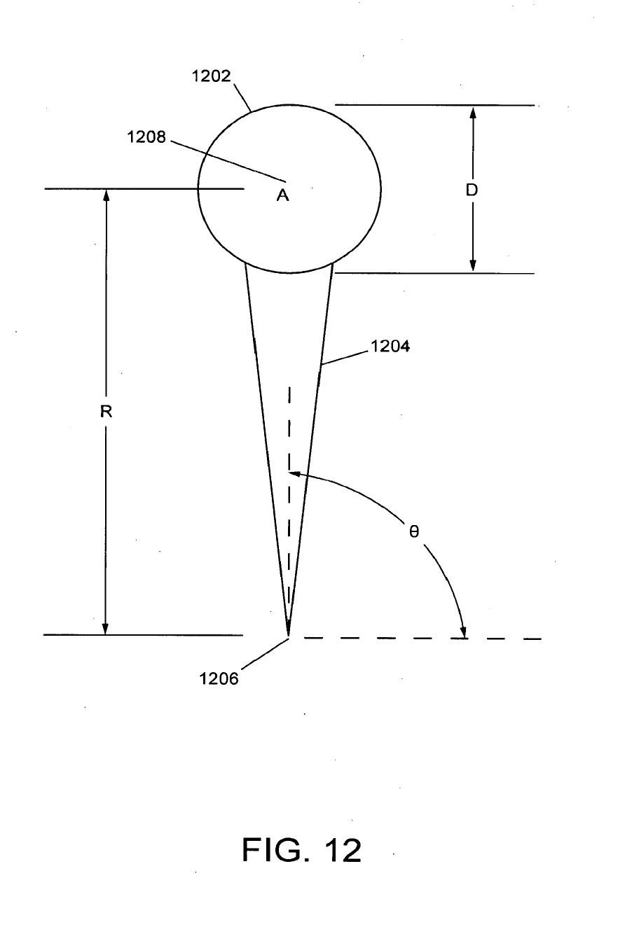

FIG. 12 illustrates one embodiment of a map pin to mark the location of a point on a bitmap map. FIG. 12 illustrates one embodiment of map pin 1200 to mark a point on a bitmap map (e.g., bitmap maps 836, 1010 above or bitmap map 1300 below). Map pin 1200 may be characterized as an object having head 1202, tail 1204, tip 1206, and text, graphic or numerical indicia 1208 in head 1202, for example. Head 1202 has a diameter D. Tail 1204 has length R measured from tip 1206 to the center of head 1202. Tip 1206 is anchored to a point on the map that indicates a location of interest to the user. Indicia 1208 identifies map pin 1200 and associates it with the location point on the map. Angle θ (theta) is the angle that map pin 1200 forms relative to the location point on the map. As shown, map pin 1200 with head 1202 pointing upwardly and tip 1206 pointing downwardly has a theta of 90 degrees. The embodiments are not limited in this context.

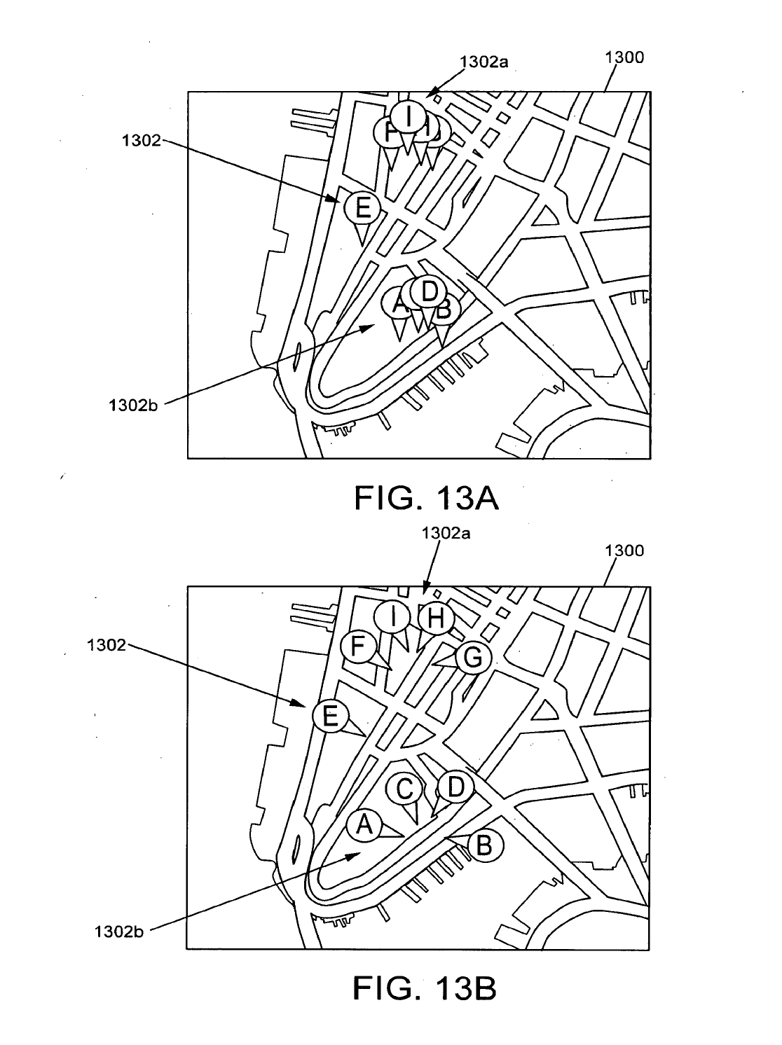

FIG. 13A illustrates one embodiment of multiple map pins overlaid on a bitmap map to mark the location of various points of interest on the bitmap map. The map pins are shown in a crowded arrangement. FIG. 13A illustrates one embodiment of multiple map pins A, B, C, D, E F, G, H, I collectively referred to as map pin arrangement 1302 overlaid on bitmap map 1300. Map pin arrangement 1302 is shown in a non-spread, crowded, configuration comprising a first map pin cluster 1302a (map pins E, F, G, H, I) and a second map pin cluster 1302b (map pins A, B, C, D). Map pins A, B, C, D, E F, G, H, I reference various points of interest on map 1300. A dense distribution of map pins in a geographic region of map 1300 may cause some or all map pins to obscure other proximate map pins. This may make it more difficult for the user to select a map pin or view a point of interest associated with a map pin. For example, in first map pin cluster 1302a, map pins E and I are not obstructed, map pin F is partially obstructed, and map pins G and H are mostly obstructed. In second map pin cluster 1302b, map pin D is not obstructed, map pins A and B are partially obstructed, and map pin C is mostly obstructed. The user may readily select any one of map pins D, E, and I with a high degree of confidence because they are not obstructed by other map pins. Map pins A, B, and F are partially obstructed so the user may find it somewhat more difficult to select them with a high degree of confidence. Map pins C, G, and H are mostly obstructed. The user cannot identify these map pins and thus cannot select map pins C, G, and H with an adequate degree of confidence. Points marked by map pins A, B, C, D, E F, G, H, I may be selected by the user by locating a cursor over the map pin. It will be difficult, however, for the user to select an obstructed map pin (e.g., map pins C, G, and H) or partially obstructed map pins (e.g., map pins A, B, and F) because the desired map pins are hidden behind other map pins. To remove these obstructions, the position of map pins A, B, C, D, E F, G, H, I relative to each other may be rearranged by map pin spread module 519. Under control of map pin spread module 519, map pins A, B, C, D, E F, G, H, I are moved relative to each other, while remaining anchored to the respective points on map 1300, until they no longer obstruct each other. The embodiments are not limited in this context.

FIG. 13B illustrates one embodiment of multiple spread-out map pins overlaid on a bitmap map to mark the location of various points of interest on the bitmap map after processing by pin spread module 519. FIG. 13B illustrates one embodiment of map pins A, B, C, D, E F, G, H, I spread out by pin spread module 519 so as not to obstruct each other. Map pin spread module 519 may be executed automatically to reposition the substantial concentration of map pins A, B, C, D, E F, G, H, I overlaid on map 1300 and to prevent map pin obstructions. Accordingly, map pins A, B, C, D, E F, G, H, I do not obstruct each other and the respective points of interest are clearly displayed.

Map pin spread module 519 defines map pins A, B, C, D, E F, G, H, I as objects and repositions them on map 1300 while maintaining the map pins anchored to their respective points of interest. Under the control of map pin spread module 519, objects associated with map pins A, B, C, D, E F, G, H, I may be characterized by a force vector. The force vector has a predetermined magnitude with a “repelling” nature pointing outwardly from each map pin such that map pins A, B, C, D, E F, G, H, I repel each other. The vector forces are updated in an iterative manner until an equilibrium state is achieved where none of the map pins A, B, C, D, E F, G, H, I are obstructed and the user has a clear view of the location of each map pin A, B, C, D, E F, G, H, I overlaid on the map and can select a desired map pin with a high degree of confidence. In one embodiment, a map pin may be repositioned by rotating it about tip 1206, by elongating tail 1204 or a combination of both. The operation of one embodiment of map pin spread module 519 is described below. The embodiments are not limited in this context.

In one embodiment, map pin spread module 519 controls the movement of map pins A, B, C, D, E F, G, H, I automatically. As previously described each pin may be formed of head 1202, tail 1204, tip 1206, and indicia 1208. The map pin may be rotated about tip 1206 and stretched out by elongating tail 1204. Accordingly, if a point on map 1300 referenced by a map pin is obstructed by other map pins, the map pins can be rotated about the respective tips 1206 and/or tails 1206 can be elongated if rotation alone is not sufficient to clear the view of all map pins in map pin arrangement 1302. The embodiments are not limited in this context.

The operation of map pin spread module 519 is now described with reference to FIGS. 12, 13A, and 13B. Map pin 1200 may be created as an object defined by one or more predetermined properties, methods that apply to the object, and functions that manage the relationships between two or more objects. In one embodiment, a map pin object may be defined by one or more of the following predetermined properties: (1) coordinates of tip 1206 to mark the point of interest; (2) length of tail 1204, R, to indicate the distance from the point of interest to the center of head 1202; (3) angle of rotation θ measured from tip 1206 of tail 1204, e.g., the point of interest; (4) coordinates of the center of head 1202; (5) indicia 1208, e.g., letter, number, graphic, located in head 1202 to reference map pin 1200; and (6) force vector applied to map pin 1200 by other map pins proximate to map pin 1200. The embodiments are not limited in this context.

One or more methods (i.e., algorithms) may be applied to a map pin object. For example, a constructor method may be used to create a new map pin object. The constructor method initializes the properties associated with the map pin object. Another method may be used to update the center of head of map pin 1200 relative to the center of head 1202, for example. The update center of head method recalculates the coordinates of the center of head 1202 and stores it in memory, for example. The distance between any two heads from the respective perimeters of the heads may be calculated by a distance measurement method. This method determines the distance between the perimeter edges of heads to determine the shortest distance therebetween. As a practical matter, if the heads overlap, the distance between them may be set to zero, for example. A set force method stores force vectors for forces acting from the heads. The force vectors may be referred to herein as repellent force vectors or repellent forces to indicate that the force vectors have a certain magnitude and direction pointing outwardly from the map pin to act on proximate pins. Accordingly, two or more proximate map pins near a point of interest on map 1300 apply repelling forces of predetermined magnitudes relative to each other. The magnitude of the forces relative to each map pin determines their movement and final position while tip 1206 remain anchored to the point of interest on map 1300. Accordingly, an apply force method retrieves the stored force vectors from memory and applies them to move the map pins. Initially, the module attempts to apply the entire force vector, or as much of the force vector as possible, to rotate a map pin without changing the length of the tail. If there is a remainder force vector after maximum rotation is achieved, the remainder force vector is applied to lengthen the tail. The embodiments are not limited in this context.

One or more functions may be executed to mange the relationships between objects (e.g., between map pins). An update position function may be executed whenever a point of interest is added or removed from map 1300 or whenever a user zooms in/out on a point of interest on map 1300. The update position function may be invoked multiple times in an iterative manner to update the positions of map pins in map pin arrangement 1302 until the motion of the map pins stabilizes, e.g., there is no substantial movement of the map pins. It will be appreciated that under certain conditions map pin arrangement 1302 may not stabilize and one or more map pins may toggle or jiggle between positions based on the forces acting on each map pin. In these situations, one of the positions may be selected to stabilize the map pins. Otherwise, the update position function may include a minimum threshold force required to move a particular map pin. If the resultant force acting on a map pin is less than the threshold, the map pin remains stationary. In other implementations, the update position function may be called a predetermined limited number of times to prevent jiggling. The update position function applies repelling forces between heads of proximate map pins or between heads and tails of proximate map pins. For example, the update position function determines the current forces acting on each map pin A, B, C, D, E, F, G, H, I stores the forces acting on each map pin in the respective map pin objects. The repellent forces then are applied to each map pin A, B, C, D, E, F, G, H, I. In response, each map pin A, B, C, D, E, F, G, H, I moves according to the applied force magnitude and direction. The forces are recalculated and applied in an iterative manner until none of map pins A, B, C, D, E, F, G, H, I obstruct each other or a point of interest.

In one embodiment, map pin spread module 519 may be implemented according to one or more algorithm represented by the following pseudo-code. The implementation of map pin spread module 519 is described below with reference to map pin 1200, which is representative of any map pins A, B, C, D, E, F, G, H, I in map pin arrangement 1302. Map pin spread module 519 may define constants and tunable variables. Tunable variables may include values that can be tuned to change the behavior of map pin arrangement 1302. Behavior of map pin arrangement 1302 refers to how two or more map pins interact with each other based on the force vectors associated with each map pin A, B, C, D, E, F, G, H, I. For example, a tunable variable may include a total number of map pins that may be overlaid on a bitmap map, the diameter of head 1202 in pixels, the minimum length of tail 1204 from a point of interest on map 1300 to the center of head 1202, constant force coefficients for map pin 1200 movement (e.g., map pin 1200 can rotate about tip 1206 or tail 1204 can be elongated), maximum length of tail 1204, and the number of times to update map pin positions between redraws of map 1300. Constant force coefficients to adjust force for tail 1206 elongation movements include coefficients to adjust movements of map pin 1200 where the length of tail 1204 is allowed to change in accordance with an applied force. Constant force coefficients to adjust for map pin 1200 rotation movements include coefficient to adjust movements of map pin 1200 where the length of tail 1204 is not allowed to change with an applied force. Global variables may include an array of map pins, such as map pins A, B, C, D, E, F, G, H, I in map pin arrangement 1302, number of map pins allocated, and stabilization flag to indicate if map pin arrangement 1302 is stable or whether additional updates may be needed.

Accordingly, the following variables may define a map pin 1200 and a map pin arrangement 1302:

NumPins=the total number of pins supported on any given map;

PinHeadSize=the diameter size of a head;

MinTailLength=the minimum length of a tail;

ForceMultiplier=a force factor for a pin;

ForceReductionCoeff=a force reduction coefficient for a pin;

FixedForceReductionCoeff=a fixed force reduction coefficient for a pin;

MaxRadius=the maximum radius of a head; and

NumIterations=the number of times to recalculate pin positions for a given map display.

A map pin may be defined by the following additional variables. For example, map pin 1200 may be defined by coordinates “(x, y)” that represent the pixel coordinates of where tip 1206 of tail 1204 is located on map 1300. The coordinates “(gx, gy)” of head 1202 represent the center of head 1202. Indicia 1208 may be located in head 1202 and may be represented by the character “c.” A force vector “(fx, fy)” associated with map pin 1200 accumulates forces applied to the corresponding head 1202 during processing. “fx” is the force acting on head 1202 in the “x” direction and “fy” is the force acting on head 1202 in the “y” direction. The length or radius “R” of tail 1204 is determined from tip 1206 (e.g., the point of interest) to the center of head 1202. Angle theta or θ is the angle that map pin 1200 is pointing to relative to the point of interest on map 1300. A constructor initializes the variables c, x, y, radius, and theta for map pin 1200, and then calculates a center of head for map pin 1200. As radius R or angle theta of map pin 1200 changes, the following function in pseudo-code form updates the location of the center of head of map pin 1200:

```
UpdateCenterOfHead)
  {
    gx = (x + cos(theta)*radius);
    gy = (y − sin(theta)*radius);
  }
```

Once the variables are initialized and the center of head of each map pin is updated, the distance between each map pin in map pin arrangement 1302 is calculated. The distance from the perimeter edge of a first map pin to the perimeter edge of a second map pin “p” may be calculated by calculating the distance from the center of the first map pin to the center of the second map pin. If the head of the first map pin and the head of the second map pin overlap, as a practical matter, the distance between them may be set to zero. Otherwise, the distance between the perimeter edges of the first and second map pins may be determined as the distance between the centers of the first and second map pins minus map pin diameter “D” (PinHeadSize). The distance from the perimeter edge of a first map pin to the perimeter edge of a second map pin “p” may be calculated according to the following pseudo-code:

```
getDistanceToHeadEdge(Pin p)
  {
    x = p.gx;
    y = p.gy;
    CenterToCenter = sqrt((gx−x)*(gx−x) + (gy−y)*(gy−y));
    if (CenterToCenter < PinHeadSize) {
      EdgeToEdge = 0;
    } else {
      EdgeToEdge = CenterToCenter − PinHeadSize;
    }
    return EdgeToEdge;
  }
```

The distance from the perimeter edge of the first head to the tip of the second map pin may be calculated by determining the distance from the center of the first head to tip of the second map pin. If the first head overlaps the tip of the second map pin, as a practical matter, the distance between them may be set to zero. Otherwise, the distance may be calculated as the distance between the tip of the second map pin and the center of the head of the first map pin minus the head radius R (PinHeadSize/2). The distance from the perimeter edge of the first head to the tip of the second map pin may be calculated according to the following pseudo-code:

```
getDistanceToPoint(Pin p)
  {
    PointToCenter = sqrt((gx−x)*(gx−x) + (gy−y)*(gy−y));
    if (PointToCenter < PinHeadSize/2) {
      PointToEdge = 0;
    } else {
      PointToEdge = PointToCenter − PinHeadSize/2;
    }
    return PointToEdge;
  }
```

A force vector may be stored in memory as follows:

```
setForce(fx, fy)
  {
    fx = fx*ForceMultiplier;
    fy = −fy*ForceMultiplier;
  }
```

A force vector may be applied to a map pin. A logic true condition is returned if a substantial change occurs in the position of the map pin after applying the force. The force is initially applied to rotate the map pin. If the map pin is maximally rotated and there is a remainder force, it is applied to change the length of the tail. The function returns a true condition if a substantial change occurred. For example, the force is initially applied to the map pin as though the length of the tail cannot change. The magnitude of the force vector is reduced by the amount that was actually applied to the map pin. The remaining force, if any, is applied to the map pin to change the length of the tail. If the tail becomes shorter than a predetermined minimum length, the tail length is reset. The force vector may be applied to a map pin according to the following pseudo-code:

```
ApplyForceBoth( )
  {
      rc = ApplyForceMapPinRotation( );
      rc = ApplyForceTailElongation ( );
    if (abs(radius) < MinTailLength) {
      this.radius=radius;
      this.theta=theta;
      UpdateCenterOfHead);
      rc=true;
    }
  }
```

A tail elongation force applied to a map pin, enables the tail to change length. The force vector may be scaled to a predetermined level. The force vector is then added to the center of head. A new angle from the new center of head position relative to the tip and a new pin radius R (e.g., the distance from the tip to the center of head) is calculated. To remove rounding errors, the center of head may be recalculated. The radius R may be reset if it exceeds a predetermined maximum length. The center of head is recalculated and the force vector is reset. The tail elongation force may be applied to the map pin to enable the tail to change length according to the following pseudo-code:

```
ApplyForceTailElongation( )
  {
    gx += fx;
    gy −= fy;
    theta = atan2(y−gy, gx−x);
    dy = y−gy;
    dx = x−gx;
    radius = sqrt(dy*dy+dx*dx);
    updateCenterOfHead( )
    if (radius > MaxRadius) {
      radius = MaxRadius;
      UpdateCenterOfHead( );
    }
  }
```

It will be appreciated that the term atan2(y−gy, gx−x) is the arctangent(y−gy/gx−x) unless (gx−x)=0, in which case it returns π/2 or −π/2 depending on the sign of (y−gy).

A rotation force applied to a map pin is applied to rotate the map pin without changing the length of the tail. An angle at which the force is to be applied is calculated. The difference between the angle of the force vector and the angle of the map pin is calculated. The sine of the difference of these angles is the fractional portion of the force that is applied to rotating the map pin. The magnitude of the force is then calculated. If a substantial force is applied directly against the map pin such that rotation of the map pin would not naturally occur, the map pin may be moved a random bit. The angle of the map pin may be changed by a suitable value. The location of the center of head of the map pin is recalculated. The force may be reduced by the amount used up in the previous operation. If the map pin movement causes the map pin arrangement to become unstable, a logic true condition is returned. The rotation force may be applied to rotate the map pin without changing the length of the tail according to the following pseudo-code:

```
ApplyForceFixedRotation( )
  {
    ForceAngle = atan2(fy, fx);
    PinAngle = theta;
    AngleDiff = ForceAngle − PinAngle;
    FractionApplied = sin(AngleDiff);
    Magnitude = sqrt(fx*fx+fy*fy);
    if (Magnitude >= 1 && PercentApplied < .01) {
      if (Random(2) > 1) {
        theta += .011;
      } else {
        theta −= .011;
      }
    } else {
      theta += (Magnitude * PercentApplied) *
FixedForceReductionCoeff;
    }
    UpdateCenterOfHead( );
    fx *= 1−PercentApplied;
    fy *= 1−PercentApplied;
    if (abs(origTheta − mtheta) > 0.01) {
      return true;
    } else {
      return false;
    }
  }
}
```

It will be appreciated that the term atan2(fy, fx) is the arctangent(fy/fx) unless (fx)=0, in which case it returns π/2 or −π/2 depending on the sign of (fy).

Multiple iterations of the map pin position recalculation routine may be executed as follows:

```
RecalculatePinPositions( )
{
  if (Unstable) {
    for (iter=0; Unstable && iter < NumIterations; iter++) {
      UpdatePositions( );
    }
  }
}
```

All map pin positions may be updated slightly. The unstable flag is reset and is set to logic true if any of the many pins move substantially from their previous position. The iterations are applied to every map pin in the map pin arrangement. The force exerted on a current map pin by every other map pin is calculated as follows.

First, the force between the heads is calculated. The distance between the heads and the force values are cubed. If the map pins are within one pixel of each other, the distance may be set to unity because the forces may be too strong for the granularity of the current iterations. The force angle between the centers of heads is calculated. The force angle may be defined as the angle from pin “I” to pin “j” in the iteration. If the map pins are very close, overlap, and point in the same direction, the force angle is set to 90 degrees from its true angle. This causes the map pins to spread apart even though no natural force would have that effect, for example. The force angle components are then calculated.

Second, the force between the “j” tip and the “i” head is calculated for every iteration. The distance between the tip and the head is calculated and cubed. If the map pins are within one pixel of each other, the distance may be set to unity because the forces may get too strong for the granularity of these iterations. The angle between the tip and the center of head is calculated. This angle represents the angle of the force, and may be defined as the angle from pin “i” to pin “j” in the iteration. The force vector components are calculated and added to the existing force vector for the current map pin in the iteration. The force is stored in memory if it is strong enough to overcome static friction. This force is applied once all the forces are calculated for all the map pins in the map pin arrangement. After the forces are calculated, they are applied to the map pins. A map pin that moves substantially may be flagged to indicate an unstable map pin arrangement (e.g., map pins may jiggle without settling because of the effect of the forces). The unstable flag is used to trigger additional iterations to stabilize the map pin arrangement.

The force between the heads and the force between the “j” tip and the “i” head may be calculated according to the following pseudo-code:

```
UpdatePositions( )
{
  ForceMult = 0.1;
  StaticFrictionPoint = 0.05;
  Unstable = false;
  for (i=0; i < NumPins; i++) {
    for (j=0; j < NumPins; j++) {
      if (i != j) {
        distance = Pins[i].getDistanceToHeadEdge(Pins[j]);
        distance *= distance;
        distance *= distance;
        if (abs(distance) < 1) {
          distance = 1;
        }
        dx = Pins[j].gx − Pins[i].gx;
        dy = Pins[j].mgy − Pins[i].gy;
        theta = atan2(dy, dx);
        if (abs(theta) < 0.1 && distance == 1) {
          if (i < j) {
            theta = Pins[i].theta + 3.141592/2;
          } else {
            theta = Pins[j].theta − 3.141592/2;
          }
        }
        fx −= forceMult * cos(theta) / distance;
        fy −= forceMult * sin(theta) / distance;
        distance = Pins[i].getDistanceToPoint(Pins[j]);
        distance *= distance;
        distance *= distance;
        if (abs(distance) < 1) {
          distance = 1;
        }
        dx = Pins[j].mx − Pins[i].mgx;
        dy = Pins[j].my − Pins[i].mgy;
        theta = atan2(dy, dx);
        fx −= forceMult * cos(theta) / distance;
        fy −= forceMult * sin(theta) / distance;
      }
    }
    if (sqrt(fx*fx+fy*fy) > staticFrictionPoint) {
      Pins[i].setForce(fx,fy);
    }
  }
  for (i=0; i < NumPins; i++) {
    if (Pins[i].applyForce( )) {
      Unstable = true;
    }
  }
}
```

A more complete example of pseudo-code to implement one embodiment of the map pin spread module 519 described herein is provided in the Appendix attached hereto.

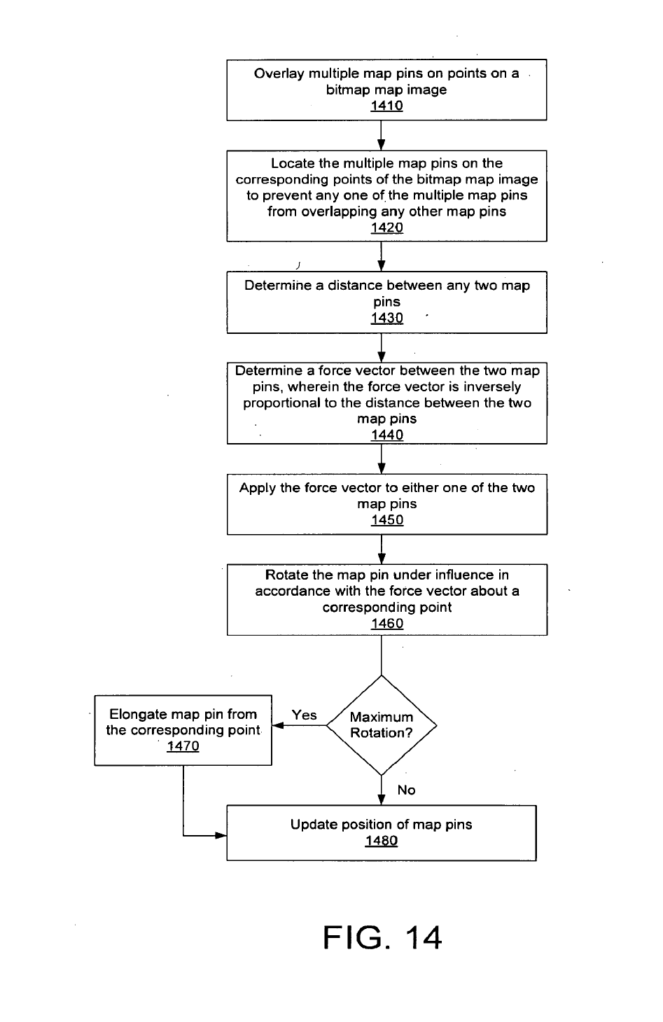

FIG. 14 illustrates one embodiment of a logic flow diagram to implement a map pin spread module. FIG. 14 illustrates one embodiment of logic flow diagram 1400. Logic flow diagram 1400 may be representative of the operations executed by one or more embodiments described herein, such as map pin spread module 519, for example. Accordingly, map pin spread module 519 overlays 1410 multiple map pins on points on a bitmap map image (or a vector-based map image) and locates 1420 the multiple map pins on the corresponding points of the bitmap map image to prevent any one of the multiple map pins from overlapping any other map pins. Map pin spread module determines 1430 a distance between any two of the multiple map pins and determines 1440 a force vector between the two multiple map pins, wherein the force vector is inversely proportional to the distance between the two multiple map pins. The force vector is applied 1450 to either one of the two map pins and the map pin under influence is rotated 1460 in accordance with the force vector about a corresponding point. The map pin is elongated 1470 from the corresponding point if the map pin reaches maximum rotation and there is a remainder force vector. The position of each of the map pins is updated 1480.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, also may mean that two or more elements are not in direct contact with each other, but yet still co-operate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory 406. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

APPENDIX
PSEUDOCODE

```
{
float pi = 3.14159;
int kNumPins = 10;
int kPinHeadSize = 25;
int kMinTailLength = 25;
int kForceMultiplier=5;
float kForceReductionCoeff=0.1;
float kFixedForceReductionCoeff=0.3333;
int gMaxRadius = 40;
int kNumIterations=100;
Pin[ ] gPins;
int gNumPins = kNumPins;
boolean gUnstable = false;
class Pin {
  int mx;
  int my;
  int mgx;
  int mgy;
  float mfx;
  float mfy;
  float mtheta;
  Pin(int x, int y, char c) {
    mc = c;
    mx = x;
    my = y;
    mradius = 25;
    mtheta = pi/2;
    updateCenterOfHead( );
  }
  void updateCenterOfHead ( )
  {
    mgx = (int) (mx + cos(mtheta)*mradius);
    mgy = (int) (my − sin(mtheta)*mradius);
  }
  float getDistanceToHeadEdge(Pin p)
  {
    int x;
    int y;
    x = p.mgx;
    y = p.mgy;
    float centerToCenter;
    float edgeToEdge;
    centerToCenter = sqrt((mgx−x)*(mgx−x) + (mgy−y)*(mgy−y));
    if (centerToCenter < kPinHeadSize) {
      edgeToEdge = 0;
    } else {
      edgeToEdge = centerToCenter − kPinHeadSize;
    }
    return edgeToEdge;
  }
  float getDistanceToPoint(Pin p)
  {
    int x = p.mx;
    int y = p.my;
    float pointToCenter;
    float pointToEdge;
    pointToCenter = sqrt((mgx−x)*(mgx−x) + (mgy−y)*(mgy−y));
    if (pointToCenter < kPinHeadSize/2) {
      pointToEdge = 0;
    } else {
      pointToEdge = pointToCenter − kPinHeadSize/2;
    }
    return pointToEdge;
  }
  void setForce(float fx, float fy)
  {
    mfx = fx*kForceMultiplier;
    mfy = −fy*kForceMultiplier;
  }
  boolean applyForce( )
  {
    boolean rc;
    rc = applyForceBoth( );
    mfx = 0;
    mfy = 0;
    return rc;
  }
  boolean applyForceBoth( )
  {
    boolean rc;
    rc = applyForceFixedRotation( );
    int radius=mradius;
    float theta=mtheta;
    rc = applyForceTailElongation ( );
    if (abs(mradius) < kMinTailLength) {
      this.mradius=radius;
      this.mtheta=theta;
      updateCenterOfHead( );
      rc=true;
    }
    mfx = 0;
    mfy = 0;
    return rc;
  }
  boolean applyForceTailElongation( )
  {
    boolean rc;
    float scaleFactor = kForceReductionCoeff;
    mfx *= scaleFactor;
    mfy *= scaleFactor;
    mgx += mfx;
    mgy −= mfy;
    mtheta = atan2(my−mgy, mgx−mx);
    int dy;
    int dx;
    dy = my−mgy;
    dx = mx−mgx;
    mradius = (int) sqrt(dy*dy+dx*dx);
    updateCenterOfHead( );
    if (mradius > gMaxRadius) {
      mradius = gMaxRadius;
      updateCenterOfHead( );
    }
    mfx = 0;
    mfy = 0;
    return true;
  }
    boolean applyForceFixedRotation( )
    {
      float forceAngle;
      float pinAngle;
      float angleDiff;
      float percentApplied;
      float magnitude;
      float origTheta;
      origTheta = mtheta;
      forceAngle = atan2(mfy, mfx);
      pinAngle = mtheta;
      angleDiff = forceAngle − pinAngle;
      percentApplied = sin(angleDiff);
      magnitude = sqrt(mfx*mfx+mfy*mfy);
      if (magnitude >= 1 && percentApplied < .01) {
        if (random(2) > 1) {
          mtheta += .011;
        } else {
          mtheta −= .011;
        }
      } else {
        mtheta += (magnitude * percentApplied) *
        kFixedForceReductionCoeff;
      }
      updateCenterOfHead( );
      mfx *= 1−percentApplied;
      mfy *= 1−percentApplied;
      if (abs(origTheta − mtheta) > 0.01) {
        return true;
      } else {
        return false;
      }
    }
  }
  void recalculatePinPositions( )
  {
    int numIterations=kNumIterations;
    int i;
    if (gUnstable) {
      int iter;
      int fm;
      for (iter=0; gUnstable && iter < numIterations; iter++) {
        updatePositions( );
      }
    }
  }
  void updatePositions( )
  {
    int i;
    int j;
    float forceMult = .1;
    float staticFrictionPoint = 0.05;
    gUnstable = false;
    for (i=0; i < gNumPins; i++) {
      float fx;
      float fy;
      float theta;
      fx = 0;
      fy = 0;
      for (j=0; j < gNumPins; j++) {
        if (i != j) {
          float distance;
          float dx;
          float dy;
          distance = gPins[i].getDistanceToHeadEdge(gPins[j]);
          distance *= distance;
          distance *= distance;
          if (abs(distance) < 1) {
            distance = 1;
          }
          dx = gPins[j].mgx − gPins[i].mgx;
          dy = gPins[j].mgy − gPins[i].mgy;
          theta = atan2(dy, dx);
          if (abs(theta) < 0.1 && distance == 1) {
            if (i < j) {
              theta = gPins[i].mtheta + 3.141592/2;
            } else {
              theta = gPins[j].mtheta − 3.141592/2;
            }
          }
          fx −= forceMult * cos(theta) / distance;
          fy −= forceMult * sin(theta) / distance;
          distance = gPins[i].getDistanceToPoint(gPins[j]);
          distance *= distance;
          distance *= distance;
          if (abs(distance) < 1) {
            distance = 1;
          }
          dx = gPins[j].mx − gPins[i].mgx;
          dy = gPins[j].my − gPins[i].mgy;
          theta = atan2(dy, dx);
          fx −= forceMult * cos(theta) / distance;
          fy −= forceMult * sin(theta) / distance;
        }
      }
      if (sqrt(fx*fx+fy*fy) > staticFrictionPoint) {
        gPins[i].setForce(fx,fy);
      }
    }
    for (i=0; i < gNumPins; i++) {
      if (gPins[i].applyForce( )) {
        gUnstable = true;
      }
    }
  }
```

1-44. (canceled)

45. A handheld navigation unit, comprising:
a housing configured to be held in a hand when in use;
a display coupled to the housing configured to display a map and a plurality of items on the map based on the locations of the items;
a user input device; and
a processing circuit configured to receive user selection of one of the plurality of items via the user input device, to display an action to be taken with the selected item, wherein in response to user input, the processing circuit is configured initiate a telephone call using a telephone number associated with the selected item.

46. The handheld navigation unit of claim 45, wherein the display is configured to display a name and telephone number of the selected item in response to user selection of the item.

47. The handheld navigation unit of claim 46, wherein the display is configured to display a plurality of actions to be taken with the selected item in response to user selection of the item, wherein the processing circuit is configured to provide directions to the user in response to user selection of one of the plurality of actions.

48. The handheld navigation unit of claim 47, wherein the display is configured to display map markers associated with each of the plurality of items displayed on the map.

49. The handheld navigation unit of claim 47, wherein each of the plurality of actions is displayed with underlining, wherein in response to user selection of the action, the processing circuit is configured to launch an application to perform the action.
